(19) United States
(12) Patent Application Publication
(10) Pub. No.: US 2022/0069348 A1
(43) Pub. Date: Mar. 3, 2022

(54) FLAME-RESISTANT QUASI-SOLID HYBRID ELECTROLYTE FOR SAFE LITHIUM BATTERIES AND PRODUCTION METHOD

(71) Applicant: Global Graphene Group, Inc., Dayton, OH (US)

(72) Inventors: Hui He, Dayton, OH (US); Aruna Zhamu, Springboro, OH (US); Bor Z. Jang, Centerville, OH (US)

(21) Appl. No.: 17/009,278

(22) Filed: Sep. 1, 2020

(51) Int. Cl. H01M 10/0565; H01M 10/0525; H01M 2/16; H01M 10/0569; H01M 10/0567

(52) U.S. Cl. CPC H01M 10/0565; H01M 10/0525; H01M 2/1673; H01M 2200/00; H01M 10/0567; H01M 2300/0028; H01M 2300/0082; H01M 10/0569

(57) ABSTRACT

A rechargeable lithium cell comprising two electrolyte compositions: (a) a first electrolyte composition (in physical contact with the cathode and the anode of the cell) contains a lithium salt dissolved in a mixture of a liquid solvent and a flame-retardant additive, having a lithium salt concentration from 1.5 M to 14.0 M; and (b) a second electrolyte composition, comprising a polymer electrolyte in ionic contact with the first electrolyte composition and being disposed substantially between the anode and the cathode, between the separator and the cathode and/or between the separator and the anode. The polymer electrolyte substantially does not permeate into the anode or the cathode.

### FIELD

The present disclosure provides a non-flammable hybrid electrolyte composition and a lithium battery (primary and secondary battery) containing such a hybrid electrolyte composition.

### BACKGROUND

Rechargeable lithium-ion (Li-ion), lithium metal, lithium-sulfur, and Li metal-air batteries are considered promising power sources for electric vehicle (EV), hybrid electric vehicle (HEV), and portable electronic devices, such as lap-top computers and mobile phones. Lithium as a metal element has the highest lithium storage capacity (3,861 mAh/g) compared to any other metal or metal-intercalated compound as an anode active material (except Li_{4.4}Si, which has a specific capacity of 4,200 mAh/g). Hence, in general, Li metal batteries (having a lithium metal anode) have a significantly higher energy density than lithium-ion batteries (having a graphite anode).

Historically, rechargeable lithium metal batteries were produced using non-lithiated compounds having relatively high specific capacities, such as TiS₂, MoS₂, MnO₂, CoO₂, and V₂O₅, as the cathode active materials, which were coupled with a lithium metal anode. When the battery was discharged, lithium ions were transferred from the lithium metal anode to the cathode through the electrolyte and the cathode became lithiated. Unfortunately, upon repeated charges and discharges, the lithium metal resulted in the formation of dendrites at the anode that ultimately caused internal shorting, thermal runaway, and explosion. As a result of a series of accidents associated with this problem, the production of these types of secondary batteries was stopped in the early 1990's giving ways to lithium-ion batteries.

Even now, cycling stability and safety concerns remain the primary factors preventing the further commercialization of Li metal batteries (e.g. Lithium-sulfur and Lithium-transition metal oxide cells) for EV, HEV, and microelectronic device applications. Again, cycling stability and safety issues of lithium metal rechargeable batteries are primarily related to the high tendency for Li metal to form dendrite structures during repeated charge-discharge cycles or overcharges, leading to internal electrical shorting and thermal runaway. This thermal runaway or even explosion is caused by the organic liquid solvents used in the electrolyte (e.g. carbonate and ether families of solvents), which are unfortunately highly volatile and flammable.

Many attempts have been made to address the dendrite and thermal runaway issues. However, despite these earlier efforts, no rechargeable Li metal batteries have succeeded in the market place. This is likely due to the notion that these prior art approaches still have major deficiencies. For instance, in several cases, the anode or electrolyte structures designed for prevention of dendrites are too complex. In others, the materials are too costly or the processes for making these materials are too laborious or difficult. In most of the lithium metal cells and lithium-ion cells, the electrolyte solvents are flammable. An urgent need exists for a simpler, more cost-effective, and easier to implement approach to preventing Li metal dendrite-induced internal short circuit and thermal runaway problems in Li metal batteries and other rechargeable batteries.

Parallel to these efforts and prompted by the aforementioned concerns over the safety of earlier lithium metal secondary batteries led to the development of lithium-ion secondary batteries, in which pure lithium metal sheet or film was replaced by carbonaceous materials (e.g. natural graphite particles) as the anode active material. The carbonaceous material absorbs lithium (through intercalation of lithium ions or atoms between graphene planes, for instance) and desorbs lithium ions during the re-charge and discharge phases, respectively, of the lithium-ion battery operation. The carbonaceous material may comprise primarily graphite that can be intercalated with lithium and the resulting graphite intercalation compound may be expressed as LiₓC₆, where x is typically less than 1.

Although lithium-ion (Li-ion) batteries are promising energy storage devices for electric drive vehicles, state-of-the-art Li-ion batteries have yet to meet the cost, safety, and performance targets. Li-ion cells typically use a lithium transition-metal oxide or phosphate as a positive electrode (cathode) that de/re-intercalates Li⁺ at a high potential with respect to the carbon negative electrode (anode). The specific capacity of lithium transition-metal oxide or phosphate based cathode active material is typically in the range from 140-170 mAh/g. As a result, the specific energy of commercially available Li-ion cells is typically in the range from 120-220 Wh/kg, most typically 150-180 Wh/kg. These specific energy values are two to three times lower than what would be required for battery-powered electric vehicles to be widely accepted.

Furthermore, the same flammable solvents previously used for lithium metal secondary batteries are also used in most of the lithium-ion batteries. Despite the notion that there is significantly reduced propensity of forming dendrites in a lithium-ion cell (relative to a lithium metal cell), the lithium-ion cell has its own intrinsic safety issue. For instance, the transition metal elements in the lithium metal oxide cathode are highly active catalysts that can promote and accelerate the decomposition of organic solvents, causing thermal runaway or explosion initiation to occur at a relatively low electrolyte temperature (e.g. <200° C., as opposed to normally 400° C. without the catalytic effect).

Ionic liquids (ILs) are a new class of purely ionic, salt-like materials that are liquid at unusually low temperatures. The official definition of ILs uses the boiling point of water as a point of reference: “Ionic liquids are ionic compounds which are liquid below 100° C.”. A particularly useful and scientifically interesting class of ILs is the room temperature ionic liquid (RTIL), which refers to the salts that are liquid at room temperature or below. RTILs are also referred to as organic liquid salts or organic molten salts. An accepted definition of an RTIL is any salt that has a melting temperature lower than ambient temperature.

Although ILs were suggested as a potential electrolyte for rechargeable lithium batteries due to their non-flammability, conventional ionic liquid compositions have not exhibited satisfactory performance when used as an electrolyte likely due to several inherent drawbacks: (a) ILs have relatively high viscosity at room or lower temperatures; thus being considered as not amenable to lithium ion transport; (b) For Li—S cell uses, ILs are capable of dissolving lithium polysulfides at the cathode and allowing the dissolved species to migrate to the anode (i.e., the shuttle effect remains severe); and (c) For lithium metal secondary cells, most of the ILs strongly react with lithium metal at the anode, continuing to consume Li and deplete the electrolyte itself during repeated charges and discharges. These factors lead to relatively poor specific capacity (particularly under high current or high charge/discharge rate conditions, hence lower power density), low specific energy density, rapid capacity decay and poor cycle life. Furthermore, ILs remain extremely expensive. Consequently, as of today, no commercially available lithium battery makes use of an ionic liquid as the primary electrolyte component.

With the rapid development of hybrid (HEV), plug-in hybrid electric vehicles (HEV), and all-battery electric vehicles (EV), there is an urgent need for anode and cathode materials and electrolytes that provide a rechargeable battery with a significantly higher specific energy, higher energy density, higher rate capability, long cycle life, and safety. One of the most promising energy storage devices is the lithium-sulfur (Li—S) cell since the theoretical capacity of Li is 3,861 mAh/g and that of S is 1,675 mAh/g. In its simplest form, a Li—S cell consists of elemental sulfur as the positive electrode and lithium as the negative electrode. The lithium-sulfur cell operates with a redox couple, described by the reaction S₈+16Li↔8Li₂S that lies near 2.2 V with respect to Li⁺/Li°. This electrochemical potential is approximately ⅔ of that exhibited by conventional positive electrodes. However, this shortcoming is offset by the very high theoretical capacities of both Li and S. Thus, compared with conventional intercalation-based Li-ion batteries, Li—S cells have the opportunity to provide a significantly higher energy density (a product of capacity and voltage). Values can approach 2,500 Wh/kg or 2,800 Wh/l based on the combined Li and S weight or volume (not based on the total cell weight or volume), respectively, assuming complete reaction to Li₂S. With a proper cell design, a cell-level specific energy of 1,200 Wh/kg (of cell weight) and cell-level energy density of 1,400 Wh/l (of cell volume) should be achievable. However, the current Li-sulfur products of industry leaders in sulfur cathode technology have a maximum cell specific energy of 400 Wh/kg (based on the total cell weight), far less than what could be obtained in real practice.

In summary, despite its considerable advantages, the rechargeable lithium metal cell in general and the Li—S cell and the Li-air cell in particular are plagued with several major technical problems that have hindered its widespread commercialization:
(1) Conventional lithium metal secondary cells (e.g., rechargeable Li metal cells, Li—S cells, and Li-Air cells) still have dendrite formation and related internal shorting and thermal runaway issues. Also, conventional Li-ion cells still make use of significant amounts of flammable liquids (e.g. propylene carbonate, ethylene carbonate, 1,3-dioxolane, etc) as the primary electrolyte solvent, risking danger of explosion;
(2) The Li—S cell tends to exhibit significant capacity degradation during discharge-charge cycling. This is mainly due to the high solubility of the lithium polysulfide anions formed as reaction intermediates during both discharge and charge processes in the polar organic solvents used in electrolytes. During cycling, the lithium polysulfide anions can migrate through the separator and electrolyte to the Li negative electrode whereupon they are reduced to solid precipitates (Li₂S₂ and/or Li₂S), causing active mass loss. In addition, the solid product that precipitates on the surface of the positive electrode during discharge can become electrochemically irreversible, which also contributes to active mass loss.
(3) More generally speaking, a significant drawback with cells containing cathodes comprising elemental sulfur, organosulfur and carbon-sulfur materials relates to the dissolution and excessive out-diffusion of soluble sulfides, polysulfides, organo-sulfides, carbon-sulfides and/or carbon-polysulfides (hereinafter referred to as anionic reduction products) from the cathode into the rest of the cell. This phenomenon is commonly referred to as the Shuttle Effect. This process leads to several problems: high self-discharge rates, loss of cathode capacity, corrosion of current collectors and electrical leads leading to loss of electrical contact to active cell components, fouling of the anode surface giving rise to malfunction of the anode, and clogging of the pores in the cell membrane separator which leads to loss of ion transport and large increases in internal resistance in the cell.

In response to these challenges, new electrolytes, protective films for the lithium anode, and solid electrolytes have been developed. Some interesting cathode developments have been reported recently to contain lithium polysulfides; but, their performance still fall short of what is required for practical applications. Despite the various approaches proposed for the fabrication of high energy density rechargeable cells containing elemental sulfur, organo-sulfur and carbon-sulfur cathode materials, or derivatives and combinations thereof, there remains a need for materials and cell designs that (a) retard the out-diffusion of anionic reduction products, from the cathode compartments into other components in these cells, (b) improve the battery safety, and (c) provide rechargeable cells with high capacities over a large number of cycles.

Again, lithium metal (including pure lithium, alloys of lithium with other metal elements, or lithium-containing compounds) still provides the highest anode specific capacity as compared to essentially all other anode active materials (except pure silicon, but silicon has pulverization issues). Lithium metal would be an ideal anode material in a lithium-sulfur secondary battery if dendrite related issues, such as fire and explosion danger, could be addressed. In addition, there are several non-lithium anode active materials that exhibit high specific lithium-storing capacities (e.g., Si, Sn, SnO₂, and Ge as an anode active material) in a lithium ion battery wherein lithium is inserted into the lattice sites of Si, Sn, SnO₂, or Ge in a charged state. These potentially useful anode materials have been largely ignored in the prior art Li—S cells.

Our research group has previously discovered a quasi-solid electrolyte strategy (Hui He, Yanbo Wang, Aruna Zhamu, and Bor Z. Jang, “Lithium Secondary Batteries Containing a Non-flammable Quasi-solid Electrolyte,” U.S. Pat. No. 9,368,831 (Jun. 14, 2016)). This strategy maintains that if the concentration of a lithium salt dissolved in an organic liquid solvent exceeds 3.5 M (particularly if >5 M), the liquid electrolyte behaves like a solid, having the ability to render the electrolyte in a Li-ion cell essentially non-flammable, stop lithium dendrite penetration in a lithium metal cell, and prevent the shuttle effect in a Li—S cell. However, an electrolyte having a lithium salt concentration higher than 3.5 M makes it difficult to inject electrolyte into dry cells when the battery cells are made. When the salt concentration exceeds 5 M, the electrolyte typically would not flow well (having a solid-like viscosity) and cannot be injected. This implies that the solid-like electrolyte can become incompatible with the current practice of producing lithium batteries in industry, which entails the production of a dry cell, followed by injection of a liquid electrolyte and sealing off of the electrolyte-filled cell. Further, the lithium salt is typically much more expensive than the solvent itself and, thus, a higher salt concentration means a higher electrolyte cost. Consequently, there is reluctance to make use of this more expensive solid-like electrolyte that would also require a change to different production equipment.

Hence, a general object of the present disclosure is to provide a safe, non-flammable, yet relatively less dense quasi-electrolyte electrolyte system for a rechargeable lithium cell that is compatible with existing battery production facilities. The electrolyte must be sufficiently high in lithium salt concentration to ensure non-flammability and yet also maintain adequate flowability (fluidity) to enable injection of liquid electrolyte into dry battery cells. These two appear to be mutually conflicting requirements.

In addition, the battery must also exhibit a high energy density, high power density, long cycle life, and no danger of explosion due to the. This lithium cell includes the lithium metal secondary cell (e.g. Li—S, Li—TiS₂, Li—MoS₂, Li—VO₂, and Li-air, just to name a few), lithium-ion cell (e.g. graphite-LiMn₂O₄, Si—LiₓNi_{y}Mn_{z}O₂, etc), Li-ion sulfur cell (e.g. prelithiated Si—S cell), and hybrid lithium cell (wherein at least one electrode operates on lithium insertion or intercalation).

A specific object of the present disclosure is to provide a rechargeable Li—S battery that exhibits an exceptionally high specific energy or high energy density and a high level of safety. One specific technical goal of the present disclosure is to provide a safe Li metal-sulfur or Li ion-sulfur cell having a long cycle life and a cell specific energy greater than 400 Wh/Kg, preferably greater than 500 Wh/Kg, and more preferably greater than 600 Wh/kg (all based on the total cell weight).

Another specific object of the present disclosure is to provide a safe lithium-sulfur cell that exhibits a high specific capacity (higher than 1,200 mAh/g based on the sulfur weight, or higher than 1,000 mAh/g based on the cathode composite weight, including sulfur, conducting additive and conductive substrate, and binder weights combined, but excluding the weight of cathode current collector). The specific capacity is preferably higher than 1,400 mAh/g based on the sulfur weight alone or higher than 1,200 mAh/g based on the cathode composite weight. This must be accompanied by a high specific energy, good resistance to dendrite formation, good resistance to thermal runaway, no possibility of an explosion, and a long and stable cycle life.

It may be noted that in most of the open literature reports (scientific papers) on Li—S cells, scientists choose to express the cathode specific capacity based on the sulfur weight or lithium polysulfide weight alone (not on the total cathode composite weight), but unfortunately a large proportion of non-active materials (those not capable of storing lithium, such as conductive additive and binder) is typically used in their Li—S cells. Similarly, for lithium-vanadium oxide cells, scientists also tend to report the cathode specific capacity based on the vanadium oxide weight only. For practical usage purposes, it is more meaningful to use the cathode composite weight-based capacity value.

A specific object of the present disclosure is to provide a rechargeable lithium-sulfur cell based on rational materials and battery designs that overcome or significantly reduce the following issues commonly associated with conventional Li—S cells: (a) dendrite formation (internal shorting); (b) extremely low electric and ionic conductivities of sulfur, requiring large proportion (typically 30-55%) of non-active conductive fillers and having significant proportion of non-accessible or non-reachable sulfur or lithium polysulfides); (c) dissolution of lithium polysulfide in electrolyte and migration of dissolved lithium polysulfides from the cathode to the anode (which irreversibly react with lithium at the anode), resulting in active material loss and capacity decay (the shuttle effect); and (d) short cycle life.

Another object of the present disclosure is to provide a simple, cost-effective, and easy-to-implement approach to preventing potential Li metal dendrite-induced internal short circuit and thermal runaway problems in various Li metal and Li-ion batteries.

### SUMMARY

As a first embodiment, the present disclosure provides a rechargeable lithium battery, including a lithium metal secondary cell, a lithium-ion cell, a lithium-sulfur cell, a lithium-ion sulfur cell, a lithium-selenium cell, or a lithium-air cell. This battery features a non-flammable, safe, and high-performing electrolyte.

In certain embodiments, the rechargeable lithium cell comprises a cathode having a cathode active material, an anode having an anode active material, an optional porous separator electronically separating the anode and the cathode, a non-flammable quasi-solid electrolyte comprising two electrolyte compositions: (a) a first electrolyte composition in physical contact with the cathode and the anode, wherein the first electrolyte composition contains a lithium salt dissolved in a mixture of a liquid solvent and a flame-retardant additive, having a lithium salt concentration from 1.5 M to 14.0 M so that the electrolyte exhibits a vapor pressure less than 0.01 kPa when measured at 20° C., a vapor pressure less than 60% of the vapor pressure of the liquid solvent alone, a flash point at least 20 degrees Celsius higher than a flash point of the liquid solvent alone, a flash point higher than 150° C., or no detectable flash point; and (b) a second electrolyte composition, comprising a polymer electrolyte that is in ionic contact with the first electrolyte composition and being disposed between the anode and the cathode, between the separator and the cathode and/or between the separator and the anode. Preferably and typically, the anode and/or the cathode is substantially free of the second electrolyte composition.

In some embodiments, the flame-retardant additive, different in composition than the liquid solvent, is selected from Hydrofluoro ether (FIFE), Trifluoro propylene carbonate (FPC), Methyl nonafluorobutyl ether (MFE), Fluoroethylene carbonate (FEC), Tris(trimethylsilyl) phosphite (TTSPi), Triallyl phosphate (TAP), Ethylene sulfate (DTD), 1,3-propane sultone (PS), Propene sultone (PES), Alkylsiloxane (Si—O), Alkyylsilane (Si—C), liquid oligomeric silaxane (—Si—O—Si—), tetraethylene glycol dimethylether (TEGDME), canola oil, or a combination thereof and the additive-to-said liquid solvent ratio in said mixture is from 5/95 to 95/5 by weight.

The additive-to-liquid solvent ratio in the mixture is from 5/95 to 95/5 by weight, preferably from 15/85 to 85/15 by weight, further preferably from 25/75 to 75/25 by weight, and most preferably from 35/65 to 65/35 by weight.

In certain embodiments, the lithium salt concentration is from 1.75 M to 7.0 M. In certain preferred embodiments, the concentration is from 2.0 M to 5.0 M.

The polymer electrolyte preferably comprises a polymer selected from poly(ethylene oxide) (PEO), polypropylene oxide (PPO), poly(ethylene glycol) (PEG), poly(acrylonitrile) (PAN), poly(methyl methacrylate) (PMMA), poly(vinylidene fluoride) (PVdF), Poly bis-methoxy ethoxyethoxide-phosphazenex, polyvinyl chloride, polydimethylsiloxane, poly(vinylidene fluoride)-hexafluoropropylene (PVDF-HFP), cyanoethyl poly(vinyl alcohol) (PVACN), a pentaerythritol tetraacrylate (PETEA)-based polymer, an aliphatic polycarbonate (including poly(vinylene carbonate) (PVC), poly(ethylene carbonate) (PEC), poly(propylene carbonate) (PPC), and poly(trimethylene carbonate) (PTMC)), a single Li-ion conducting solid polymer electrolyte with a carboxylate anion, a sulfonylimide anion, or sulfonate anion, a crosslinked electrolyte of poly(ethylene glycol) diacrylate (PEGDA) or poly(ethylene glycol) methyl ether acrylate, a sulfonated derivative thereof, or a combination thereof.

The polymer electrolyte composition preferably contains a polymer that can be cured or cross-linked. This polymer may be initially in a monomer or oligomer state that remains as a liquid which can be injected into the battery cell and then cured or crosslinked after being injected into the cell. Examples include cyanoethyl poly(vinyl alcohol) (PVACN), a pentaerythritol tetraacrylate (PETEA)-based polymer, poly(vinylene carbonate) (PVC), poly(ethylene carbonate) (PEC), poly(propylene carbonate) (PPC), and poly(trimethylene carbonate) (PTMC).

We have surprisingly discovered that, for the first electrolyte composition, the flammability of any organic solvent can be effectively suppressed provided that a sufficiently high amount of a lithium salt (from 1.5 M to 14.0 M or higher) is added to and dissolved in the mixture of a liquid solvent and a liquid additive (selected from the above list) to form a solid-like or quasi-solid electrolyte. We have further surprising observed that the required salt amount (concentration) can be significantly reduced (e.g. from 5 M to below 3 M, or from 3.5 M to below 2.5 M or even below 2.0 M) if a sufficient amount of at least one of the flame retardant additives given in the above list is added to the liquid solvent to form a mixture. The presence of such a flame retardant additive unexpectedly enables us to achieve both non-flammability and adequate flowability of a liquid electrolyte, the two requirements that would have been considered mutually exclusive.

The first electrolyte composition is designed to permeate into the internal structure of both the anode and the cathode to be in physical contact or ionic contact with the anode active material in the anode and the cathode active material in the cathode.

In general, such a quasi-solid electrolyte exhibits a vapor pressure less than 0.01 kPa (when measured at 20° C.) and less than 0.1 kPa (when measured at 100° C.). In many cases, the vapor molecules are practically too few to be detected. The high solubility of the lithium salt in an otherwise highly volatile solvent has effectively prevented the flammable gas molecules from initiating a flame even at an extremely high temperature (e.g. using a torch, as demonstrated in FIG. 1(A) and FIG. 1(B)). The flash point of the quasi-solid electrolyte is typically at least 20 degrees (often >50 degrees) higher than the flash point of the same neat organic solvent alone. In most of the cases, either the flash point is higher than 150° C. or no flash point can be detected. The electrolyte just would not catch on fire or get ignited. Any accidentally initiated flame does not sustain for longer than a few seconds. This is a highly significant discovery, considering the notion that fire and explosion concern has been a major impediment to widespread acceptance of battery-powered electric vehicles. This new technology could potentially reshape the landscape of EV industry.

Another surprising element of the present disclosure is the notion that we are able to dissolve a high concentration of a lithium salt in an organic solvent to form an electrolyte suitable for use in a rechargeable lithium battery. This concentration is typically greater than a lithium salt molecular ratio (molecular fraction) of approximately >0.12 (corresponding to approximately >1.5 M or 1.5 mole/liter), more typically >0.15 (approximately >1.9 M), can be >0.2 (>2.5 M), >0.3 (>3.75 M) and even >0.4 (>5 M). The equivalency between molecular fraction figure and molar concentration figure (mole/liter) varies from one salt/solvent combination to another.

In the instant disclosure, with an electrolyte additive selected and added, the concentration is typically and preferably from 1.5 M to 5.0 M, still more typically and preferably from 2.0 M to 3.5M, and most preferably from 2.5 M to 3.0 M. Such a high concentration of lithium salt in a solvent has not been generally considered possible or desirable. Indeed, in general, it has not been possible to achieve concentration of lithium salt in an organic solvent higher than 3.5 M and, in general, 1 M is a standard concentration in lithium-ion battery.

After an extensive and in-depth study, we came to further discover that the apparent solubility of a lithium salt (e.g., in the first electrolyte composition) could be significantly increased if (a) initially a highly volatile co-solvent is used to increase the amount of lithium salt dissolved in the solvent mixture first and then (b) this volatile co-solvent is partially or totally removed once the dissolution procedure is completed. Quite unexpectedly, the removal of this co-solvent typically did not lead to precipitation or crystallization of the lithium salt out of the solution even though the solution would have been in a highly supersaturated state. This novel and unique approach appears to have produced a material state wherein most of the solvent molecules are retained or captured by lithium salt ions that are not volatile. Hence, very few solvent molecules are able to escape into the vapor phase. Consequently, very few volatile gas molecules can be present to initiate or sustain a flame. This has not been suggested as technically possible or viable in any previous report.

It may be noted that a good scientist in the field of chemistry or materials science would anticipate that such a high salt concentration would make the electrolyte behave like a solid with an extremely high viscosity and, hence, this electrolyte would not be amenable to fast diffusion of lithium ions therein. Consequently, the scientist would tend to expect that a lithium battery containing such a solid-like electrolyte would not and could not exhibit a high capacity at a high charge-discharge rate or under a high current density condition (i.e. the battery should have a poor rate capability). Contrary to these expectations, all the lithium cells containing such a quasi-solid electrolyte deliver surprisingly high energy density and high power density for a long cycle life. The quasi-solid electrolytes as herein disclosed are conducive to facile lithium ion transport. This surprising observation is manifested by a high lithium ion transference number (TN), to be further explained in a later section of this specification. We have found that the quasi-solid electrolytes provide a TN greater than 0.4 (typically in the range from 0.4-0.8), in contrast to the typical values of 0.1-0.2 in all lower concentration electrolytes (e.g. <1.5 M) used in all current Li-ion and Li—S cells.

The first electrolyte composition of the disclosed rechargeable lithium cell preferably contains a quasi-solid electrolyte having a lithium ion transference number greater than 0.4, preferably and typically greater than 0.6, and most preferably and typically greater than 0.7. It may be noted that the lithium ion transference number of an electrolyte (given the same type and concentration of lithium salt in the same solvent) can vary from a battery type to another; e.g. from a lithium metal cell (where the anode is Li metal) to a lithium-ion cell (where the anode is Sn). The total amount of lithium available for moving back and forth between the anode and the cathode is an important factor that can dictate this transference number.

The liquid solvent may be selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphates (LiPF₃(CF₂CF₃)₃), lithium bisperfluoro-ethylsulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The lithium salt is preferably selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphates (LiPF₃(CF₂CF₃)₃), lithium bisperfluoro-ethylsulfonylimide (LiBETI), lithium bis(trifluoromethanesulphonyl)imide, lithium bis(fluorosulphonyl)imide, an ionic liquid-based lithium salt, a combination thereof, or a combination thereof with lithium trifluoromethanes-ulfonimide (LiTFSI).

The polymer electrolyte in the second electrolyte composition is designed to further reduce the flammability of the battery cell. In the presently disclosed lithium secondary cell, typically and preferably the first electrolyte is incorporated into the battery cell first. This can be conducted by incorporating the first electrolyte into the anode and the cathode before these electrodes, along with the porous separator or ion-permeable membrane, are assembled into a cell. Alternatively and preferably, the anode, the cathode, and the porous separator or ion-permeable membrane are assembled into a dry cell, which is then injected with the first electrolyte composition. The first electrolyte does not fully occupy the internal space of the dry electrolyte, leaving some room to accommodate the second electrolyte composition. Once an adequate amount of time is allowed for permeation of the first electrolyte to reach the anode active materials in the anode and the cathode active materials in the cathode, one may then introduce the second electrolyte composition into the cell. Since the internal structures of both the anode and the cathode have been substantially loaded with the first electrolyte, the second electrolyte tends to stay near the separator or a space between the anode and the electrode.

As indicated earlier, the polymer may be initially in a monomer or oligomer state that remains as a liquid which is capable of being injected and flowed into the battery cell and then cured or crosslinked after being injected into the cell. The polymer electrolyte typically will not permeate into the interior of the anode or the interior of the cathode.

There are no particular restrictions on the types of anode active materials or cathode active materials that can be sued in the presently disclosed lithium battery, which can be a primary battery or a secondary battery.

In a preferred rechargeable lithium cell, the cathode active material may be selected from a metal oxide, a metal oxide-free inorganic material, an organic material, a polymeric material, sulfur, lithium polysulfide, selenium, or a combination thereof. The metal oxide-free inorganic material may be selected from a transition metal fluoride, a transition metal chloride, a transition metal dichalcogenide, a transition metal trichalcogenide, or a combination thereof. In a particularly useful embodiment, the cathode active material is selected from FeF₃, FeCl₃, CuCl₂, TiS₂, TaS₂, MoS₂, NbSe₃, MnO₂, CoO₂, an iron oxide, a vanadium oxide, or a combination thereof, if the anode contains lithium metal as the anode active material. The vanadium oxide may be preferably selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

In a rechargeable lithium cell (e.g., the lithium-ion battery cell), the cathode active material may be selected to contain a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

In a preferred lithium metal secondary cell, the cathode active material preferably contains an inorganic material selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

In another preferred rechargeable lithium cell (e.g. a lithium metal secondary cell or a lithium-ion cell), the cathode active material contains an organic material or polymeric material selected from Poly(anthraquinonyl sulfide) (PAQS), lithium oxocarbons (including squarate, croconate, and rhodizonate lithium salts), oxacarbon (including quinines, acid anhydride, and nitrocompound), 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material (redox-active structures based on multiple adjacent carbonyl groups (e.g., “C₆O₆”-type structure, oxocarbons), Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)6), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAM), calixquinone, Li₄C₆O₆, Li₂C₆O₆, Li₆C₆O₆, or a combination thereof.

The thioether polymer may be selected from Poly[methanetetryl-tetra(thiomethylene)] (PMTTM), Poly(2,4-dithiopentanylene) (PDTP), or Poly(ethene-1,1,2,2-tetrathiol) (PETT) as a main-chain thioether polymer, in which sulfur atoms link carbon atoms to form a polymeric backbones. The side-chain thioether polymers have polymeric main-chains that consist of conjugating aromatic moieties, but having thioether side chains as pendants. Among them Poly(2-phenyl-1,3-dithiolane) (PPDT), Poly(1,4-di(1,3-dithiolan-2-yl)benzene) (PDDTB), poly(tetrahydrobenzodithiophene) (PTHBDT), and poly[1,2,4,5-tetrakis(propylthio)benzene] (PTKPTB) have a polyphenylene main chain, linking thiolane on benzene moieties as pendants. Similarly, poly[3,4(ethylenedithio)thiophene] (PEDTT) has polythiophene backbone, linking cyclo-thiolane on the 3,4-position of the thiophene ring.

In yet another preferred rechargeable lithium cell, the cathode active material contains a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof. This class of lithium secondary batteries have a high capacity and high energy density.

Still another preferred embodiment of the present disclosure is a rechargeable lithium-sulfur cell or lithium-ion sulfur cell containing a sulfur cathode having sulfur or lithium polysulfide as a cathode active material.

In any of the aforementioned rechargeable lithium cell (e.g. a lithium metal secondary cell or a lithium-ion cell), the first organic liquid solvent may be selected from 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofloroether, a combination thereof, or a combination with a room temperature ionic liquid solvent.

In a preferred lithium metal secondary cell (excluding lithium-sulfur cell) or a lithium-ion cell, the lithium salt may be selected from lithium perchlorate (LiClO₄), lithium hexafluoro phosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphates (LiPF₃(CF₂CF₃)₃), lithium bisperfluoro-ethylsulfonylimide (LiBETI), lithium bis(trifluoromethanesulphonyl)imide, lithium bis(fluorosulphonyl)imide, an ionic liquid-based lithium salt, a combination thereof, or a combination with lithium trifluoromethanesulfonimide (LiTFSI).

In an embodiment, the first or the second electrolyte composition may contain an ionic liquid solvent. The ionic liquid solvent is preferably selected from a room temperature ionic liquid having a cation selected from tetraalkylammonium, di-, tri-, or tetra-alkylimidazolium, alkylpyridinium, dialkyl-pyrrolidinium, dialkylpiperidinium, tetraalkylphosphonium, trialkylsulfonium, or a combination thereof. The room temperature ionic liquid preferably has an anion selected from BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, or a combination thereof.

In any of the aforementioned rechargeable lithium cell, the anode may contain an anode active material selected from lithium metal, a lithium metal alloy, a mixture of lithium metal or lithium alloy with a lithium intercalation compound, a lithiated compound, lithiated titanium dioxide, lithium titanate, lithium manganate, a lithium transition metal oxide, Li₄Ti₅O₁₂, or a combination thereof.

Alternatively, the anode may contain an anode active material selected from the group consisting of: (a) silicon (Si), germanium (Ge), tin (Sn), lead (Pb), antimony (Sb), bismuth (Bi), zinc (Zn), aluminum (Al), nickel (Ni), cobalt (Co), manganese (Mn), titanium (Ti), iron (Fe) and cadmium (Cd), and lithiated versions thereof; (b) alloys or intermetallic compounds of Si, Ge, Sn, Pb, Sb, Bi, Zn, Al, or Cd with other elements, and lithiated versions thereof, wherein said alloys or compounds are stoichiometric or non-stoichiometric; (c) oxides, carbides, nitrides, sulfides, phosphides, selenides, and tellurides of Si, Ge, Sn, Pb, Sb, Bi, Zn, Al, Fe, Ni, Co, Ti, Mn, or Cd, and their mixtures or composites, and lithiated versions thereof; (d) salts and hydroxides of Sn and lithiated versions thereof; (e) carbon or graphite materials and prelithiated versions thereof; and combinations thereof. The carbon or graphite materials may be selected from the group consisting of natural graphite particles, synthetic graphite particles, needle cokes, electro-spun nano fibers, vapor-grown carbon or graphite nano fibers, carbon or graphite whiskers, carbon nano-tubes, carbon nanowires, sheets and platelets of pristine graphene, graphene oxide, reduced graphene oxide, doped graphene or graphene oxide, and chemically functionalized graphene, and combinations thereof.

Another preferred rechargeable lithium cell is a lithium-air cell having a higher round-trip efficiency or higher resistance to capacity decay as compared to a corresponding lithium-air cell that has an electrolyte salt concentration x (molecular ratio) lower than 0.2.

The rechargeable lithium cell may further comprise a layer of protective material disposed between the anode and the electrolyte wherein the protective material is a lithium ion conductor.

The rechargeable lithium cell may further comprise a cathode current collector selected from aluminum foil, carbon- or graphene-coated aluminum foil, stainless steel foil or web, carbon- or graphene-coated steel foil or web, carbon or graphite paper, carbon or graphite fiber fabric, flexible graphite foil, graphene paper or film, or a combination thereof. A web means a screen-like structure or a metal foam, preferably having interconnected pores or through-thickness apertures. The lithium cell may further comprise an anode current collector selected from copper foil or web, carbon- or graphene-coated copper foil or web, stainless steel foil or web, carbon- or graphene-coated steel foil or web, titanium foil or web, carbon- or graphene-coated titanium foil or web carbon or graphite paper, carbon or graphite fiber fabric, flexible graphite foil, graphene paper or film, or a combination thereof.

The presently disclosed lithium-sulfur cell provides a reversible specific capacity of typically no less than 800 mAh per gram based on the total weight of exfoliated graphite worms and sulfur (or sulfur compound or lithium polysulfide) combined. More typically and preferably, the reversible specific capacity is no less than 1,000 mAh per gram and often exceeds 1,200 mAh per gram. The high specific capacity of the presently disclosed cathode, when in combination with a lithium anode, leads to a cell specific energy of no less than 600 Wh/kg based on the total cell weight including anode, cathode, electrolyte, separator, and current collector weights combined. In many cases, the cell specific energy is higher than 800 Wh/kg and, in some examples, exceeds 1,000 Wh/kg.

The presently disclosed lithium cell is not limited to lithium metal-sulfur cell or lithium-ion cell. This safe and high-performing hybrid electrolyte can be used in any lithium metal secondary cell (lithium metal-based anode coupled with any cathode active material) and any lithium-ion cell.

The disclosure also provides a method of producing the disclosed rechargeable lithium cell, the method comprising (A) preparing a lithium cell comprising an anode having an anode active material, a cathode having a cathode active material, a porous separator (or ion-permeable membrane) electronically separating the anode and the cathode, and a first electrolyte composition that permeates into the anode and/or the cathode, wherein the first electrolyte composition contains a lithium salt dissolved in a liquid solvent (with or without a flame-retardant additive), having a lithium salt concentration from 1.5 M to 14.0 M and wherein the lithium cell has an unfilled space; and (B) introducing a second electrolyte composition into the unfilled space, the second electrolyte composition comprising a polymer electrolyte that is in ionic contact with the first electrolyte composition and disposed between the anode and the cathode, between the separator and the cathode, and/or between the separator and the anode.

The method is not limited to a first electrolyte that contains a lithium salt concentration from 1.5 M to 14.0; any lithium salt concentration is suitable. Thus, the disclosure provides a method of producing a lithium cell, the method comprising (A) preparing a lithium cell comprising an anode having an anode active material, a cathode having a cathode active material, a porous separator or ion-permeable membrane electronically separating the anode and the cathode, and a first electrolyte composition that permeates into the anode and/or the cathode, wherein the first electrolyte composition contains a lithium salt dissolved in a liquid solvent and wherein said lithium cell has an unfilled space; and (B) introducing a second electrolyte composition into the unfilled space, the second electrolyte composition comprising a polymer electrolyte in ionic contact with the first electrolyte composition and being disposed between the anode and the cathode, between the separator and the cathode, and/or between the separator and the anode.

In each of the above two versions, the flame-retardant additive, different in composition than said liquid solvent, may be selected from Hydrofluoro ether (HFE), Trifluoro propylene carbonate (FPC), Methyl nonafluorobutyl ether (MFE), Fluoroethylene carbonate (FEC), Tris(trimethylsilyl)phosphite (TTSPi), Triallyl phosphate (TAP), Ethylene sulfate (DTD), 1,3-propane sultone (PS), Propene sultone (PES), Alkylsiloxane (Si—O), Alkyylsilane (Si—C), liquid oligomeric silaxane (—Si—O—Si—), Ttetraethylene glycol dimethylether (TEGDME), canola oil, or a combination thereof and said additive-to-said liquid solvent ratio in said mixture is from 5/95 to 95/5 by weight.

In either version, the polymer electrolyte may preferably comprise a polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

Preferably, in either version, step (B) comprises a procedure of introducing a precursor monomer, oligomer, or un-cured version of said polymer electrolyte into the unfilled space and then polymerizing and/or curing the precursor inside said battery cell to form said polymer electrolyte.

Preferably, step (A) comprises a procedure (i) of assembling the anode, cathode, and said separator or membrane, along with a cell housing together to form a dry battery cell having initially no electrolyte therein and a procedure (ii) of introducing a first electrolyte composition into this dry cell, enabling the first electrolyte to permeate into the anode and/or the cathode; and wherein step (B) is conducted after procedure (ii).

In either version, the method may further comprise, after procedure (ii) but before step (B), a procedure of removing a desired portion of the liquid solvent from the battery cell to create additional unfilled space. This would also serve to increase the lithium salt concentration of the first electrolyte composition.

These and other advantages and features of the present disclosure will become more transparent with the description of the following best mode practice and illustrative examples.

### BRIEF DESCRIPTION OF THE DRAWINGS

FIG. 1(A) Photos showing the results of a flammability test conducted for various electrolytes with different lithium salt concentrations (intended to serve as a first electrolyte of the presently disclosed lithium cell).

FIG. 1(B) Photo showing the result of a flammability test for a lower concentration electrolyte but having an additive, 30% FPC; LiTFSI/(DME+DOL+FPC)=0.16 or approximately 2.0 M. (intended to serve as a first electrolyte of the presently disclosed lithium cell) FIG. 2 Vapor pressure ratio data (pₛ/p=vapor pressure of solution/vapor pressure of solvent alone) as a function of the lithium salt molecular ratio x (LiTFSI/DOL), along with the theoretical predictions based on the classic Raoult's Law.

FIG. 3 Vapor pressure ratio data (pₛ/p=vapor pressure of solution/vapor pressure of solvent alone) as a function of the lithium salt molecular ratio x (LiTFSI/DME), along with the theoretical predictions based on classic Raoult's Law.

FIG. 4 Vapor pressure ratio data (pₛ/p=vapor pressure of solution/vapor pressure of solvent alone) as a function of the lithium salt molecular ratio x (LiPF₆/DOL), along with the theoretical predictions based on classic Raoult's Law.

FIG. 5 Vapor pressure ratio data (pₛ/p=vapor pressure of solution/vapor pressure of solvent alone) as a function of the lithium salt molecular ratio x (LiTFSI/DOL, LiTFSI/DME, LiPF₆/DOL), along with the theoretical predictions based on classic Raoult's Law.

FIG. 6 The Li⁺ ion transference numbers of electrolytes (e.g. LiTFSI salt/(DOL+DME) solvents) in relation to the lithium salt molecular ratio x.

FIG. 7 The Li⁺ ion transference numbers of electrolytes (e.g. LiTFSI salt/(EMImTFSI+DOL) solvents) in relation to the lithium salt molecular ratio x.

FIG. 8 The Li⁺ ion transference numbers of electrolytes (e.g. LiTFSI salt/(EMImTFSI+DME) solvents) in relation to the lithium salt molecular ratio x.

FIG. 9 The Li⁺ ion transference numbers in various electrolytes (as in FIG. 6-8) in relation to the lithium salt molecular ratio x.

FIG. 10(A) The first cycle efficiency of a graphite anode vs. Li metal in electrolyte of 2M LiPF₆ in EC-VC (70/30) and that in 2M LiPF₆ in EC—VC-FPC (60/20/20); the latter being non-flammable.

FIG. 10(B) The first cycle efficiency of a LiCO₂ cathode vs. Li metal in electrolyte of 2M LiPF₆ in EV-VC (70/30) and that in 2M LiPF₆ in EC—VC-FPC (60/20/20); the latter being non-flammable.

FIG. 11(A) Cycling performance (charge specific capacity, discharge specific capacity, and Coulomb efficiency) of a Li metal-sulfur cell containing a low-concentration electrolyte (x=0.06) of Li salt in an organic solvent) and

FIG. 11(B) representative charge-discharge curves of the same cell.

FIG. 12(A) Cycling performance (charge specific capacity, discharge specific capacity, and Coulomb efficiency) of a Li metal-sulfur cell containing a high-concentration organic electrolyte DME (x=0.3);

FIG. 12(B) Cycling behaviors of two corresponding cells having 20% FPC added to DME solvent and having salt concentrations of 2.5 M and 5 M, respectively.

FIG. 13 Ragone plots (cell power density vs. cell energy density) of two Li metal-sulfur cells each having an exfoliated graphite worm-sulfur cathode, but different electrolytes.

### DETAILED DESCRIPTION OF PREFERRED EMBODIMENTS

The present disclosure provides a safe and high-performing lithium battery, which can be any of various types of lithium-ion cells or lithium metal cells. A high degree of safety is imparted to this battery by a novel and unique electrolyte that is essentially non-flammable and would not initiate a fire or sustain a fire and, hence, would not pose explosion danger. This disclosure has solved the very most critical issue that has plagued the lithium-metal and lithium-ion industries for more than two decades.

As indicated earlier in the Background section, a strong need exists for a safe, non-flammable, yet injectable quasi-electrolyte electrolyte system for a rechargeable lithium cell that is compatible with existing battery production facilities. The electrolyte must be sufficiently high in lithium salt concentration to ensure non-flammability and yet also maintain adequate flowability (fluidity) to enable that the electrolyte can be introduced into dry battery cells. The present disclosure has solved this problem of having two conflicting requirements that appear to be mutually exclusive.

In certain embodiments, the rechargeable lithium cell comprises a cathode having a cathode active material, an anode having an anode active material, an optional porous separator electronically separating the anode and the cathode, a non-flammable quasi-solid electrolyte comprising two electrolyte compositions: (a) a first electrolyte composition in physical contact with the cathode and the anode, wherein the first electrolyte composition contains a lithium salt dissolved in a mixture of a liquid solvent and a flame-retardant additive, having a lithium salt concentration from 1.5 M to 14.0 M so that the electrolyte exhibits a vapor pressure less than 0.01 kPa when measured at 20° C., a vapor pressure less than 60% of the vapor pressure of the liquid solvent alone, a flash point at least 20 degrees Celsius higher than a flash point of the liquid solvent alone, a flash point higher than 150° C., or no detectable flash point; and (b) a second electrolyte composition, comprising a polymer electrolyte that is in ionic contact with the first electrolyte composition and being disposed between the anode and the cathode, between the separator and the cathode and/or between the separator and the anode. Preferably and typically, the anode and/or the cathode is substantially free of the second electrolyte composition.

In some embodiments, the flame-retardant additive, different in composition than the liquid solvent, is selected from Hydrofluoro ether (HFE), Trifluoro propylene carbonate (FPC), Methyl nonafluorobutyl ether (MFE), Fluoroethylene carbonate (FEC), Tris(trimethylsilyl) phosphite (TTSPi), Triallyl phosphate (TAP), Ethylene sulfate (DTD), 1,3-propane sultone (PS), Propene sultone (PES), Alkylsiloxane (Si—O), Alkyylsilane (Si—C), liquid oligomeric silaxane (—Si—O—Si—), tetraethylene glycol dimethylether (TEGDME), canola oil, or a combination thereof and the additive-to-said liquid solvent ratio in said mixture is from 5/95 to 95/5 by weight.

Most surprising and of tremendous scientific and technological significance is our discovery that the flammability of any volatile organic solvent can be effectively suppressed provided that a sufficiently high amount of a lithium salt and polymer is added to and dissolved in this organic solvent to form a solid-like or quasi-solid electrolyte. In general, such a quasi-solid electrolyte exhibits a vapor pressure less than 0.01 kPa and often less than 0.001 kPa (when measured at 20° C.) and less than 0.1 kPa and often less than 0.01 kPa (when measured at 100° C.). (The vapor pressures of the corresponding neat solvent, without any lithium salt dissolved therein, are typically significantly higher.) In many cases, the vapor molecules are practically too few to be detected.

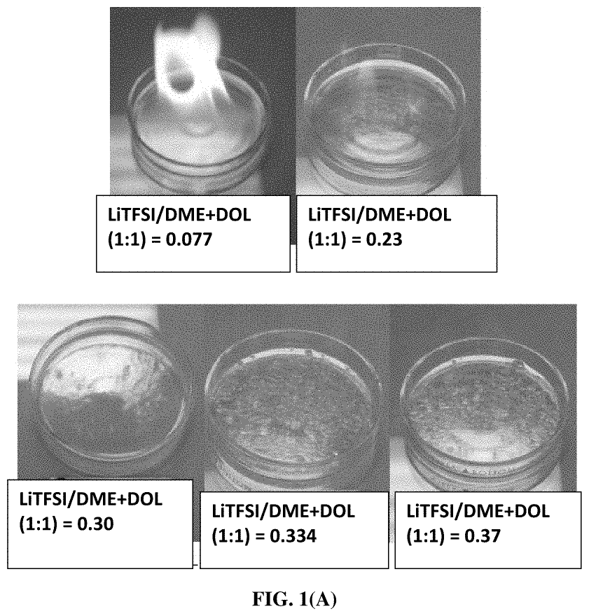

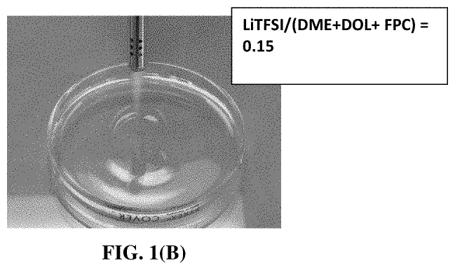

A highly significant observation is that the high concentration of the lithium salt dissolved in an otherwise highly volatile solvent (a large molecular ratio or molar fraction of lithium salt, typically >0.2, more typically >0.3, and often >0.4 or even >0.5) can dramatically curtail the amount of volatile solvent molecules that can escape into the vapor phase in a thermodynamic equilibrium condition. In many cases, this has effectively prevented the flammable gas molecules from initiating a flame even at an extremely high temperature (e.g. using a torch, as demonstrated in FIG. 1(A) and FIG. 1(B)). The flash point of the quasi-solid electrolyte is typically at least 20 degrees (often >50 degrees) higher than the flash point of the neat organic solvent alone. In most of the cases, either the flash point is higher than 150° C. or no flash point can be detected. The electrolyte just would not catch on fire. Furthermore, any accidentally initiated flame does not sustain for longer than 3 seconds. This is a highly significant discovery, considering the notion that fire and explosion concern has been a major impediment to widespread acceptance of battery-powered electric vehicles. This new technology could significantly impact the emergence of a vibrant EV industry.

However, an excessively high salt concentration could result in an excessively high electrolyte viscosity. When the lithium salt concentration exceeds approximately 3.5 M (molecular ratio or fraction >0.28), it becomes very difficult to inject the electrolyte into a well-packed dry cell to finish the cell production procedure. The injection becomes totally impossible when the salt concentration exceeds 5.0 M (molecular fraction >0.4). This has prompted us to search for solutions to this problem of having two mutually exclusive requirements (high salt concentration for non-flammability and low salt concentration for electrolyte fluidity). After extensive and in-depth studies, we have come to discover that these conflicting issues can be resolved provided certain liquid additives are added to the liquid solvent to form a mixture in which the lithium salt is dissolved to form the electrolyte. There can be one liquid solvent with one liquid additive, one liquid solvent with two liquid additives, two liquid solvents with one liquid additive, etc. in the liquid mixture. There can be multiple liquid solvents mixed with multiple liquid additives.

FIG. 1(B) is a photo showing the result of a flammability test for a lower concentration electrolyte but having an additive (30% FPC), which is a flame retardant. The electrolyte composition has a molecular ratio of LiTFSI/(DME+DOL+FPC)=0.16 or approximately 2.0 M. Even though this is a relatively low concentration among the group of quasi-solid electrolytes, this electrolyte is non-flammable when a torch was brought to be in touch with the electrolyte. This electrolyte has a relatively low viscosity, having sufficient flowability to enable electrolyte injection during battery manufacturing. Injection of electrolyte becomes more difficult when the salt concentration exceeds 3 M and becomes practically non-feasible when the salt concentration exceeds 5 M.

In the no flash point conditions of the present application, such as those demonstrated in FIG. 1(A) and FIG. 1(B), contacting the electrolyte with a butane torch does not trigger an ignition that would occur at a flash point. The flame of a butane torch is known to burn at temperatures above 1,400° C.

The polymer electrolyte preferably comprises a polymer selected from poly(ethylene oxide) (PEO), polypropylene oxide (PPO), poly(ethylene glycol) (PEG), poly(acrylonitrile) (PAN), poly(methyl methacrylate) (PMMA), poly(vinylidene fluoride) (PVdF), Poly bis-methoxy ethoxyethoxide-phosphazenex, polyvinyl chloride, polydimethylsiloxane, poly(vinylidene fluoride)-hexafluoropropylene (PVDF-HFP), cyanoethyl poly(vinyl alcohol) (PVACN), a pentaerythritol tetraacrylate (PETEA)-based polymer, an aliphatic polycarbonate (including poly(vinylene carbonate) (PVC), poly(ethylene carbonate) (PEC), poly(propylene carbonate) (PPC), and poly(trimethylene carbonate) (PTMC)), a single Li-ion conducting solid polymer electrolyte with a carboxylate anion, a sulfonylimide anion, or sulfonate anion, a crosslinked electrolyte of poly(ethylene glycol) diacrylate (PEGDA) or poly(ethylene glycol) methyl ether acrylate, a sulfonated derivative thereof, or a combination thereof.

The polymer electrolyte composition preferably contains a polymer that can be cured or cross-linked. This polymer may be initially in a monomer or oligomer state that remains as a liquid which can be injected into the battery cell and then cured or crosslinked after being injected into the cell. Examples include cyanoethyl poly(vinyl alcohol) (PVACN), a pentaerythritol tetraacrylate (PETEA)-based polymer, poly(vinylene carbonate) (PVC), poly(ethylene carbonate) (PEC), poly(propylene carbonate) (PPC), and poly(trimethylene carbonate) (PTMC).

The polymer electrolyte in the second electrolyte composition is designed to further reduce the flammability of the battery cell. In the presently disclosed lithium secondary cell, typically and preferably the first electrolyte is incorporated into the battery cell first. This can be conducted by incorporating the first electrolyte into the anode and the cathode before these electrodes, along with the porous separator or ion-permeable membrane, are assembled into a cell. Alternatively and preferably, the anode, the cathode, and the porous separator or ion-permeable membrane are assembled into a dry cell, which is then injected with the first electrolyte composition. The first electrolyte does not fully occupy the internal space of the dry electrolyte, leaving some room to accommodate the second electrolyte composition. Once an adequate amount of time is allowed for permeation of the first electrolyte to reach the anode active materials in the anode and the cathode active materials in the cathode, one may then introduce the second electrolyte composition into the cell. Since the internal structures of both the anode and the cathode have been substantially loaded with the first electrolyte, the second electrolyte tends to stay near the separator or a space between the anode and the electrode. This feature is also important in terms of isolating any potential fire-causing event (e.g. constraining any potential thermal runaway event inside the anode, not to easily spread into the cathode, and vice versa).

As indicated earlier, the polymer may be initially in a monomer or oligomer state that remains as a liquid which is capable of being injected and flowed into the battery cell and then cured or crosslinked after being injected into the cell. The polymer electrolyte typically will not permeate into the interior of the anode or the interior of the cathode.

Not wishing to be bound by theory, but we would like to offer some theoretical aspects of the presently disclosed quasi-solid electrolytes, utilized primarily as the first electrolyte in the disclosed lithium battery. From the perspective of fundamental chemistry principles, addition of solute molecules to a liquid elevates the boiling temperature of the liquid and reduces its vapor pressure and freezing temperature. These phenomena, as well as osmosis, depend only on the solute concentration and not on its type, and are called colligative properties of solutions. The original Raoult's law provides the relationship between the ratio of the vapor pressure (pₛ) of a solution to the vapor pressure (p) of the pure liquid and the molar fraction of the solute (x):

pₛ/p=e^{-x} Eq.(1a)

For a dilute solution, x<<1 and, hence, e^{-x}≈1−x. Thus, for the special cases of low solute molar fractions, one obtains a more familiar form of Raoult's law:

pₛ/p=1−x Eq.(1b)

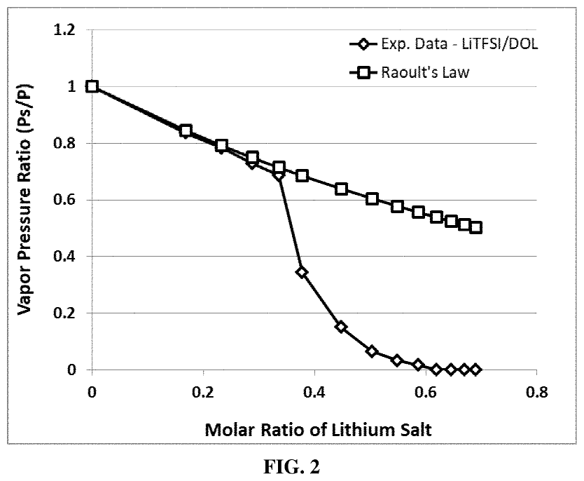

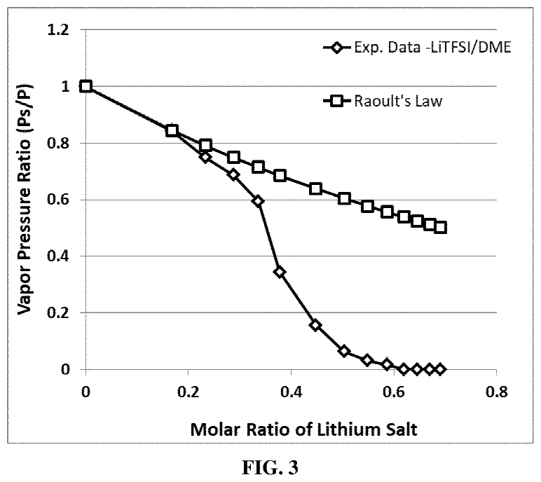

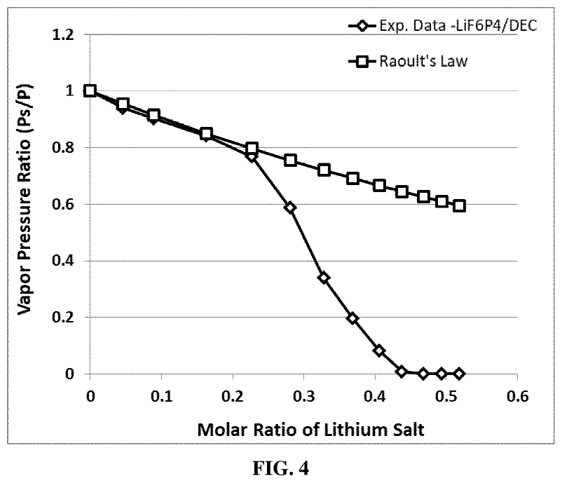

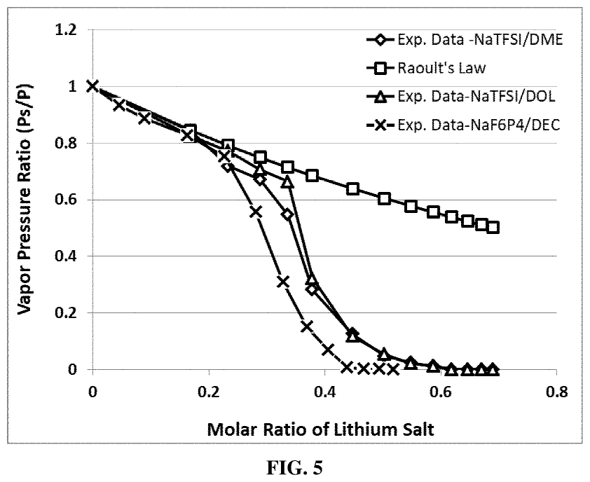

In order to determine if the classic Raoult's law can be used to predict the vapor pressures of highly concentrated electrolytes, we proceeded to investigate a broad array of lithium salt/organic solvent combinations. Some of the examples of our research results are summarized in FIG. 2-FIG. 5, where the experimental pₛ/p values are plotted as a function of the molecular ratio (molar fraction, x) for several salt/solvent combinations. Also plotted for comparison purpose is a curve based on the classic Raoult's law, Eq. (1a). It is clear that, for all types of electrolytes, the pₛ/p values follow the Raoult's law prediction until the molar fraction x reaches approximately 0.2, beyond which the vapor pressure rapidly drops to essentially zero (barely detectable). When a vapor pressure is lower than a threshold, no flame would be initiated, and we are proud to state that the present disclosure provides a platform materials chemistry approach to effectively suppress the initiation of flame.

Although deviations from Raoult's law are not uncommon in science, but this type of curve for the pₛ/p values has never been observed for any binary solution systems. In particular, there has been no study reported on the vapor pressure of ultra-high concentration battery electrolytes (with a high molecular fraction, e.g. >0.2 or >0.3) for safety considerations. This is truly unexpected and of technological and scientific significance.

Another surprising element of the present disclosure is the notion that we are able to dissolve a high concentration of a lithium salt in just about every type of commonly used battery-grade organic solvent to form a quasi-solid electrolyte suitable for use in a rechargeable lithium battery. Expressed in a more easily recognizable term, this concentration is typically greater than 3.5 M (mole/liter), more typically and preferably greater than 4 M, still more typically and preferably greater than 5 M, further more preferably greater than 7 M, and most preferably greater than 10 M. Such a high concentration of lithium salt in a solvent has not been generally considered possible. However, one must understand that the vapor pressure of a solution cannot be predicted directly and straightforwardly from the concentration value in terms of M (mole/liter). Instead, for a lithium salt, the molecular ratio x in Raoult's law is the sum of the molar fractions of positive ions and negative ions, which is proportional to the degree of dissociation of a lithium salt in a particular solvent at a given temperature. The mole/liter concentrations do not provide adequate information to enable prediction of vapor pressures.

In general, it has not been considered possible to achieve such a high concentration of lithium salt (e.g., x=0.3-0.7) in an organic solvent used in a battery electrolyte. After an extensive and in-depth study, we came to further discover that the apparent solubility of a lithium salt in a particular solvent could be significantly increased if (a) a highly volatile co-solvent is used to increase the amount of lithium salt dissolved in the solvent mixture first and then (b) this volatile co-solvent is partially or totally removed once the dissolution procedure is completed. Quite unexpectedly, the removal of this co-solvent typically did not lead to precipitation or crystallization of the lithium salt out of the solution even though the solution would have been in a highly supersaturated state. This novel and unique approach appears to have produced a material state wherein most of the solvent molecules are captured or held in place by lithium salt ions that are not volatile (actually the lithium salt being like a solid). Therefore, very few volatile solvent molecules are able to escape into the vapor phase and, hence, very few “flammable” gas molecules are present to help initiate or sustain a flame. This has not been suggested as technically possible or viable in the prior art.

Furthermore, a skilled artisan in the field of chemistry or materials science would have anticipated that such a high salt concentration should make the electrolyte behave like a solid with an extremely high viscosity and, hence, this electrolyte should not be amenable to fast diffusion of lithium ions therein. Consequently, the artisan would have expected that a lithium battery containing such a solid-like electrolyte would not and could not exhibit a high capacity at a high charge-discharge rate or under a high current density condition (i.e. the battery should have a poor rate capability). Contrary to these expectations by a person of ordinary skills or even exceptional skills in the art, all the lithium cells containing such a quasi-solid electrolyte deliver high energy density and high power density for a long cycle life. It appears that the quasi-solid electrolytes as herein disclosed are conducive to facile lithium ion transport. This surprising observation is related to a high lithium ion transference number (TN), to be further explained in a later section of this specification. We have found that the quasi-solid electrolytes provides a TN greater than 0.4 (typically in the range from 0.4-0.8), in contrast to the typical values of 0.1-0.2 in all lower concentration electrolytes (e.g. <2.0 M) used in all current Li-ion and Li—S cells.

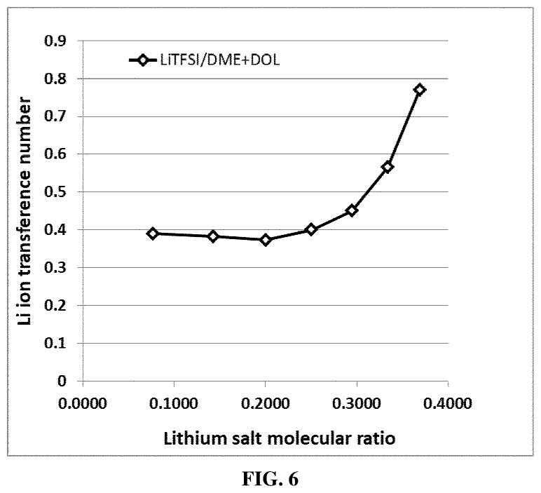

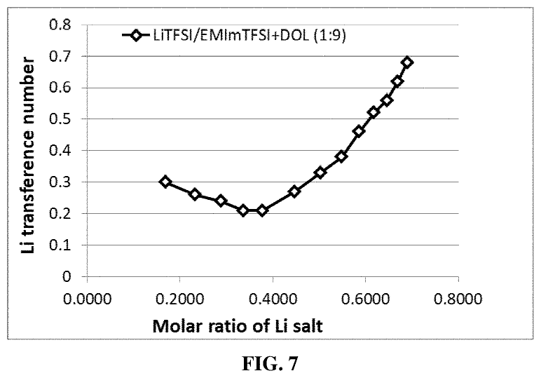

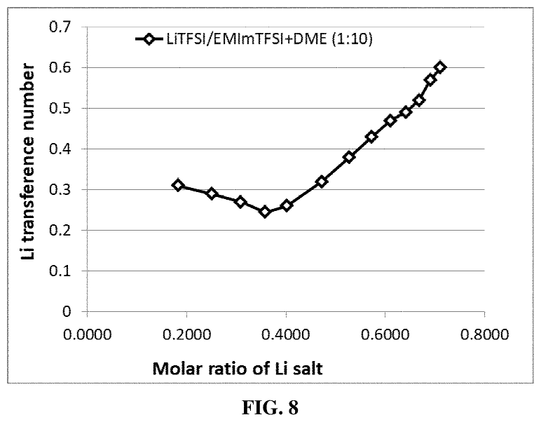

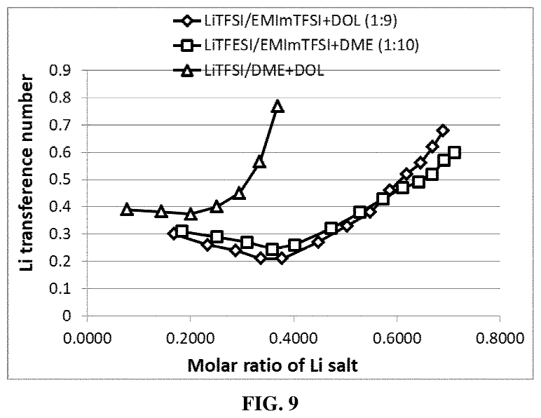

As indicated in FIG. 6-FIG. 9, the Li⁺ ion transference number in low salt concentration electrolytes decreases with increasing concentration from x=0 to x=0.2-0.35. However, beyond molecular ratios of x=0.2-0.35, the transference number increases with increasing salt concentration, indicating a fundamental change in the Li⁺ ion transport mechanism. Not wishing to be bound by theory, but we would like to offer the following scientifically plausible explanations: When Li⁺ ions travel in a low salt concentration electrolyte (e.g. x<0.2), each Li⁺ ion drags one or more solvating anions along with it. The coordinated migration of such a cluster of charged species can be further impeded if the fluid viscosity is increased (i.e. if more salt is added to the solvent).

Fortunately, when an ultra-high concentration of lithium salt (e.g., with x>0.2) is present, Li⁺ ions could significantly out-number the available solvating anions or solvent molecules that otherwise could cluster the lithium ions, forming multi-ion complex species that slow down the diffusion process of Li⁺ ions. Presumably, the high viscosity in a high-concentration electrolyte has a more significant effect on curtailing the mobility of generally larger anions than it does to smaller Li⁺ ions. This effect and the high Li⁺ ion concentration make it possible to have more “free Li⁺ ions” (those acting alone without being clustered), thereby providing a high Li⁺ transference number (hence, a facile Li⁺ transport). In other words, the lithium ion transport mechanism changes from a multi-ion complex-dominating one (with a larger hydrodynamic radius) to single ion-dominating one (with a smaller hydrodynamic radius) having a large number of available free Li⁺ ions. This observation has further asserted that Li⁺ ions can operate on quasi-solid electrolytes without compromising the rate capability of a Li—S cell. Yet, these highly concentrated electrolytes are non-flammable and safe. These combined features and advantages for battery applications have never been taught or even slightly hinted in any previous report. Theoretical aspects of the ion transference number of quasi-solid electrolytes are now presented below:

In selecting an electrolyte system for a battery, the ionic conductivity of lithium ions is an important factor to consider. The ionic conductivity of Li⁺ ions in an organic liquid-based electrolyte is on the order of 10⁻³-10⁻² S/cm and that in a solid state electrolyte is typically in the range from 10⁻⁴-10⁻⁶ S/cm. Due to the low ionic conductivity, solid-state electrolytes have not been used to any significant extent in any battery system. This is a pity since solid-state electrolyte is resistant to dendrite penetration in a lithium metal secondary cell and does not allow for dissolution of lithium polysulfide in a Li—S cell. The charge-discharge capacities of Li—S cells with a solid electrolyte are extremely low, typically 1-2 orders of magnitude lower than the theoretical capacity of sulfur. In contrast, the ionic conductivity of our quasi-solid electrolytes is typically in the range from 10⁻⁴-8×10⁻³ S/cm, sufficient for use in a rechargeable battery.

However, the overall ionic conductivity is not the only important transport parameter of a battery electrolyte. The individual transference numbers of cations and anions are also important. For instance, when viscous liquids are used as electrolytes in lithium batteries high transference numbers of Li⁺ ions in the electrolyte are needed.

The ion transport and diffusion in a liquid electrolyte consisting of only one type of cation (i.e. Li⁺) and one type of anion, plus a liquid solvent or a mixture of two liquid solvents, may be studied by means of AC impedance spectroscopy and pulsed field gradient NMR techniques. The AC impedance provides information about the overall ionic conductivity, and NMR allows for the determination of the individual self-diffusion coefficients of cations and anions. Generally, the self-diffusion coefficients of the cations are slightly higher than those of the anions. The Haven ratio calculated from the diffusion coefficients and the overall ionic conductivity is typically in the range from 1.3 to 2, indicating that transport of ion pairs or ion complexes (e.g. clusters of Lit solvating molecules) is an important feature in electrolytes containing a low salt concentration.

The situation becomes more complicated when either two different lithium salts or one ionic liquid (as a lithium salt or liquid solvent) is added to the electrolyte, resulting in a solution having at least 3 or 4 types of ions. In this case, as an example, it is advantageous to use a lithium salt containing the same anion as in the solvating ionic liquid, since the amount of dissolvable lithium salt is higher than in a mixture with dissimilar anions. Thus, the next logical question to ask is whether it is possible to improve the Li⁺ transference number by dissolving more lithium salt in liquid solvent.

The relation between the overall ionic conductivity of a three-ion liquid mixture, σ_{dc}, and the individual diffusion coefficients of the ions, Di, may be given by the Nernst-Einstein equation:

σ_{dc}=(e²/k_{B}TH_{R})[(N_{Li}⁺)(D_{Li}⁺)+(N_{A}⁺)(D_{A}⁺)+(N_{B}⁻)(D_{B}⁻)] Eq. (2)

Here, e and k_{B} denote the elementary charge and Boltzmann's constant, respectively, while Nᵢ are the number densities of individual ions. The Haven ratio, H_{R}, accounts for cross correlations between the movements of different types of ions.

Simple ionic liquids with only one type of cation and anion are characterized by Haven ratios being typically in the range from 1.3 to 2.0. A Haven ratio larger than unity indicates that ions of dissimilar charges move preferentially into the same direction (i.e. ions transport in pairs or clusters). Evidence for such ion pairs can be found using Raman spectra of various electrolytes. The values for the Haven ratios in the three-ion mixtures are in the range from 1.6 to 2.0. The slightly higher H_{R} values as compared to the electrolytes with x=0 indicate that pair formation is more prominent in the mixtures.

For the same mixtures, the overall ionic conductivity of the mixtures decreases with increasing lithium salt content x. This conductivity drop is directly related to a drop of the individual self-diffusion coefficients of all ions. Furthermore, studies on different mixtures of ionic liquids with lithium salts have shown that the viscosity increases with increasing lithium salt content x. These findings suggest that the addition of lithium salt leads to stronger ionic bonds in the liquid mixture, which slow down the liquid dynamics. This is possibly due to the Coulomb interaction between the small lithium ions and the anions being stronger than the Coulomb interactions between the larger organic cations and the anions. Thus, the decrease of the ionic conductivity with increasing lithium salt content x is not due to a decreasing number density of mobile ions, but to a decreasing mobility of the ions.

In order to analyze the individual contributions of the cations and anions to the overall ionic conductivity of the mixtures, one may define the apparent transference numbers tᵢ by:

tᵢ=NᵢDi/(ΣNᵢ/Di) Eq.(3)

As an example, in a mixture of N-butyl-N-methyl-pyrrolidinium bis(trifluoromethanesulfonyl) imide (BMP-TFSI) and lithium bis(trifluoromethanesulfonyl)imide (Li-TFSI), containing Li⁺, BMP⁺, and TFSI⁻ ions, the apparent lithium transference number t_{Li} increases with increasing Li-TFSI content; at x=0.377, t_{Li}=0.132 (vs. t_{Li}<0.1 at x<0.2), D_{Li} 0.8D_{TFSI}, and D_{BMP}≤1.6D_{TFSI}. The main reason for the higher apparent lithium transference number in the mixture is the higher number density of lithium ions.

In order to further enhance the lithium transference number in such mixtures, the number density and/or the diffusion coefficient of the lithium ions have to be further increased relative to the other ions. A further increase of the Li⁺ ion number density is generally believed to be very challenging since the mixtures tend to undergo salt crystallization or precipitation at high Li salt contents. The present disclosure has overcome this challenge. We have surprisingly observed that the addition of a very small proportion of a highly volatile organic liquid (e.g. an ether-based solvent) can significantly increase the solubility limit of some Li salt in a highly viscous organic liquid (e.g. VC) or an ionic liquid (e.g. typically from x<0.2 to x>0.3-0.6, or from typically 1-2 M to >5 M). This can be achieved with an ionic liquid (or viscous organic liquid)-to-volatile organic solvent ratio as high as 10:1, hence, keeping the volatile solvent content to a bare minimum and minimizing the potential flammability of the electrolyte.

The diffusion coefficients of the ions, as measured in the pulsed field gradient NMR (PFG-NMR) experiments, depend on the effective radius of the diffusing entities. Due to the strong interactions between Li⁺ ions and TFSI⁻ ions, Li⁺ ions can form [Li(TFSI)ₙ₊₁]ⁿ⁻ complexes. Coordination numbers up to n+1=4 have been reported in open literature. The coordination number determines the effective hydrodynamic radius of the complex and thus the diffusion coefficient in the liquid mixture. The Stokes-Einstein equation, Di=k_{B}T/(cπηrᵢ), may be used to calculate the effective hydrodynamic radius of a diffusing entity, ri, from its diffusion coefficient Di. The constant c varies between 4 and 6, depending on the shape of the diffusing entity. A comparison of the effective hydrodynamic radii of cations and anions in ionic liquids with their van der Waals radii reveals that the c values for cations are generally lower than for anions. In the case of EMI-TFSI/Li-TFSI mixtures, hydrodynamic radii for Li are in the range from 0.7-0.9 nm. This is approximately the van der Waals radius of [Li(TFSI)₂]⁻ and [Li(TFSI)₃]²⁻ complexes. In the case of the BMP-TFSI/Li-TFSI mixture with x=0.377, the effective hydrodynamic radius of the diffusing lithium complex is r_{Li}=(D_{BMP}/D_{Li})r_{BMP}≈1.1 nm, under the assumption that r_{BMP}≈0.55 nm and that the c values for BMP and for the diffusing Li complex are identical. This value for r_{Li} suggests that the lithium coordination number in the diffusing complex is at least 2 in the mixtures containing a low salt concentration.

Since the number of TFSI⁻ ions is not high enough to form a significant amount of [Li(TFSI)₃]²⁻ complexes, most lithium ions should be diffusing as [Li(TFSI)₂]⁻ complexes. If, on the other hand, higher Li salt concentrations are achieved without crystallization (e.g. in our quasi-solid electrolytes), then the mixtures should contain a considerable amount of neutral [Li(TFSI)] complexes, which are smaller (r_{[Li(TFSI)]}≈0.4 nm) and should have higher diffusivities. Thus, a higher salt concentration would not only enhance the number density of lithium ions but should also lead to higher diffusion coefficients of the diffusing lithium complexes relative to the organic cations. The above analysis is applicable to electrolytes containing either organic liquid solvents or ionic liquid solvents. In all cases, when the lithium salt concentrations are higher than a threshold, there will be an increasing number of free or un-clustered Li⁺ ions to move between the anode and the cathode when the concentration is further increased, providing adequate amount of Li⁺ ions required for intercalation/deintercalation or chemical reactions at the cathode and the anode.

In addition to the non-flammability and high lithium ion transference numbers as discussed above, there are several additional benefits associated with using the presently disclosed quasi-solid electrolytes. As one example, the quasi-solid electrolyte can significantly enhance cyclic and safety performance of rechargeable lithium batteries through effective suppression of lithium dendrite growth. It is generally accepted that dendrites start to grow in the non-aqueous liquid electrolyte when the anion is depleted in the vicinity of the electrode where plating occurs. In the ultrahigh concentration electrolyte, there is a mass of anions to keep the balance of cations (Li⁺) and anions near metallic lithium anode. Further, the space charge created by anion depletion is minimal, which is not conducive to dendrite growth. Furthermore, due to both ultrahigh lithium salt concentration and high lithium-ion transference number, the quasi-solid electrolyte provides a large amount of available lithium-ion flux and raises the lithium ionic mass transfer rate between the electrolyte and the lithium electrode, thereby enhancing the lithium deposition uniformity and dissolution during charge/discharge processes. Additionally, the local high viscosity induced by a high concentration will increase the pressure from the electrolyte to inhibit dendrite growth, potentially resulting in a more uniform deposition on the surface of the anode. The high viscosity could also limit anion convection near the deposition area, promoting more uniform deposition of Li ions. These reasons, separately or in combination, are believed to be responsible for the notion that no dendrite-like feature has been observed with any of the large number of rechargeable lithium cells that we have investigated thus far.

As another benefit example, this electrolyte is capable of inhibiting lithium polysulfide dissolution at the cathode of a Li—S cell, thus overcoming the polysulfide shuttle phenomenon and allowing the cell capacity not to decay significantly with time. Consequently, a coulombic efficiency nearing 100% along with long cycle life has been achieved. The solubility of lithium polysulfide (0 is affected by the concentration of lithium ions already present in the electrolyte by the common ion effect. The solubility product (Kₛₚ) of lithium polysulfide may be written as:

Li₂Sₙχ2 Li⁺+Sₙ²⁻;Kₛₚ=[Li⁺]²[Sₙ²⁻]=4ξₒ³;ξₒ=(Kₛₚ/4)^{1/3} (Eq.4),

where ξₒ represents the solubility of lithium polysulfide when no lithium ion is present in the solvent. If the concentration of the lithium salt in the electrolyte (C) is significantly larger than the solubility of polysulfide, the solubility of polysulfide in the electrolyte containing the concentrated lithium salt can be expressed as:

ξ/ξₒ=(2 ξₒ/C)² (Eq.5).

Therefore, when a concentrated electrolyte is used, the solubility of lithium polysulfide will be reduced significantly.

The liquid solvent utilized in the instant electrolytes may be selected from the group consisting of 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofloroether (e.g. methyl perfluorobutyl ether, MFE, or ethyl perfluorobutyl ether, EFE), and combinations thereof.

The lithium salt may be selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃ SO₂)₂), lithium bis(oxalato)borate (LiBOB), lithium oxalyldifluoroborate (LiBF₂C₂O₄), lithium nitrate (LiNO₃), Li-fluoroalkyl-phosphates (LiPF₃(CF₂CF₃)₃), lithium bisperfluoro-ethylsulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The ionic liquid is composed of ions only. Ionic liquids are low melting temperature salts that are in a molten or liquid state when above a desired temperature. For instance, an ionic salt is considered as an ionic liquid if its melting point is below 100° C. If the melting temperature is equal to or lower than room temperature (25° C.), the salt is referred to as a room temperature ionic liquid (RTIL). The IL-based lithium salts are characterized by weak interactions, due to the combination of a large cation and a charge-delocalized anion. This results in a low tendency to crystallize due to flexibility (anion) and asymmetry (cation).

Some ILs may be used as a co-solvent (not as a salt) to work with the first organic solvent of the present disclosure. A well-known ionic liquid is formed by the combination of a 1-ethyl-3-methyl-imidazolium (EMI) cation and an N,N-bis(trifluoromethane)sulphonamide (TFSI) anion. This combination gives a fluid with an ionic conductivity comparable to many organic electrolyte solutions, a low decomposition propensity and low vapor pressure up to ˜300-400° C. This implies a generally low volatility and non-flammability and, hence, a much safer electrolyte solvent for batteries.

Ionic liquids are basically composed of organic or inorganic ions that come in an unlimited number of structural variations owing to the preparation ease of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl) imide, bis(fluorosulphonyl)imide and hexafluorophosphate as anions. Useful ionic liquid-based lithium salts (not solvent) may be composed of lithium ions as the cation and bis(trifluoromethanesulphonyl)imide, bis(fluorosulphonyl)imide and hexafluorophosphate as anions. For instance, lithium trifluoromethanesulfonimide (LiTFSI) is a particularly useful lithium salt.

Based on their compositions, ionic liquids come in different classes that include three basic types: aprotic, protic and zwitterionic types, each one suitable for a specific application. Common cations of room temperature ionic liquids (RTILs) include, but are not limited to, tetraalkylammonium, di, tri, and tetra-alkylimidazolium, alkylpyridinium, dialkyl-pyrrolidinium, dialkylpiperidinium, tetraalkylphosphonium, and trialkylsulfonium. Common anions of RTILs include, but are not limited to, BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, etc. Relatively speaking, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2.3}⁻ results in RTILs with good working conductivities.

RTILs can possess archetypical properties such as high intrinsic ionic conductivity, high thermal stability, low volatility, low (practically zero) vapor pressure, non-flammability, the ability to remain liquid at a wide range of temperatures above and below room temperature, high polarity, high viscosity, and wide electrochemical windows. These properties, except for the high viscosity, are desirable attributes when it comes to using an RTIL as an electrolyte co-solvent in a rechargeable lithium cell.

There is no restriction on the type of the anode materials that can be used in practicing the present disclosure. The anode active material may contain, as an example, lithium metal foil or a high-capacity Si, SiOx, P, Sn, or SnO₂ capable of storing a great amount of lithium.

There is also no restriction on the type of the cathode materials that can be used in practicing the present disclosure. For Li—S cells, the cathode active material may contain pure sulfur (if the anode active material contains lithium), lithium polysulfide, or any sulfur containing compound, molecule, or polymer. If the cathode active material includes lithium-containing species (e.g. lithium polysulfide) when the cell is made, the anode active material can be any material capable of storing a large amount of lithium (e.g. Si, Ge, Sn, SnO₂, etc.). For other lithium secondary cells, the cathode active materials can include a transition metal fluoride (e.g. MnF₃, FeF₃, etc.), a transition metal chloride (e.g. CuCl₂), a transition metal dichalcogenide (e.g. TiS₂, TaS₂, and MoS₂), a transition metal trichalcogenide (e.g., NbSe₃), a transition metal oxide (e.g., MnO₂, CoO₂, an iron oxide, a vanadium oxide, etc.), or a combination thereof. The vanadium oxide may be selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

The rechargeable lithium metal or lithium-ion cell featuring an organic liquid solvent-based quasi-solid electrolyte containing a high lithium salt concentration may contain a cathode active material selected from, as examples, a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The disclosure also provides a method of producing the disclosed rechargeable lithium cell, the method comprising (A) preparing a lithium cell comprising an anode having an anode active material, a cathode having a cathode active material, a porous separator (or ion-permeable membrane) electronically separating the anode and the cathode, and a first electrolyte composition that permeates into the anode and/or the cathode, wherein the first electrolyte composition contains a lithium salt dissolved in a mixture of a liquid solvent and a flame-retardant additive, having a lithium salt concentration from 1.5 M to 14.0 M and wherein the lithium cell has an unfilled space; and (B) introducing a second electrolyte composition into the unfilled space, the second electrolyte composition comprising a polymer electrolyte that is in ionic contact with the first electrolyte composition and disposed between the anode and the cathode, between the separator and the cathode, and/or between the separator and the anode.

The method is not limited to a first electrolyte that contains a lithium salt concentration from 1.5 M to 14.0; any lithium salt concentration is suitable. Thus, the disclosure provides a method of producing a lithium cell, the method comprising (A) preparing a lithium cell comprising an anode having an anode active material, a cathode having a cathode active material, a porous separator or ion-permeable membrane electronically separating the anode and the cathode, and a first electrolyte composition that permeates into the anode and/or the cathode, wherein the first electrolyte composition contains a lithium salt dissolved in a liquid solvent and wherein said lithium cell has an unfilled space; and (B) introducing a second electrolyte composition into the unfilled space, the second electrolyte composition comprising a polymer electrolyte in ionic contact with the first electrolyte composition and being disposed between the anode and the cathode, between the separator and the cathode, and/or between the separator and the anode.

Preferably, in either version, step (B) comprises a procedure of introducing a precursor monomer, oligomer, or un-cured version of said polymer electrolyte into the unfilled space and then polymerizing and/or curing the precursor inside said battery cell to form said polymer electrolyte.

Preferably, step (A) comprises a procedure (i) of assembling the anode, cathode, and said separator or membrane, along with a cell housing together to form a dry battery cell having initially no electrolyte therein and a procedure (ii) of introducing a first electrolyte composition into this dry cell, enabling the first electrolyte to permeate into the anode and/or the cathode; and wherein step (B) is conducted after procedure (ii). Procedure (ii) may entail injecting a liquid electrolyte having a low lithium salt concentration dissolved in an organic solvent, for instance. This is then followed by removing some of the solvent after the electrolyte permeates into both the anode and cathode to wet the surfaces of the anode active material (e.g. particles of graphite, Si, SiO, etc.) or surfaces of cathode active materials (e.g. lithium transition metal oxides, such as NCA, NCM, LCO, and LMO).

In either version, the method may further comprise, after procedure (ii) but before step (B), a procedure of removing a desired portion of the liquid solvent from the battery cell to create additional unfilled space. This would also serve to increase the lithium salt concentration of the first electrolyte composition.

The following examples are presented primarily for the purpose of illustrating the best mode practice of the present disclosure, not to be construed as limiting the scope of the present disclosure.

### Example 1: Some Examples of Electrolytes Used in the First Electrolyte Compositions

A wide range of lithium salts can be used as the lithium salt dissolved in an organic liquid solvent (alone or in a mixture with another organic liquid or an ionic liquid). The following are good choices for lithium salts that tend to be dissolved well in selected organic or ionic liquid solvents: lithium borofluoride (LiBF₄), lithium trifluoro-methanesulfonate (LiCF₃SO₃), lithium bis-trifluoromethyl sulfonylimide (LiN(CF₃SO₂)₂ or LITFSI), lithium bis(oxalato)borate (LiBOB), lithium oxalyldifluoroborate (LiBF₂C₂O₄), and lithium bisperfluoroethy-sulfonylimide (LiBETI). A good electrolyte additive for helping to stabilize Li metal is LiNO₃. Particularly useful ionic liquid-based lithium salts include: lithium bis(trifluoro methanesulfonyl)imide (LiTFSI).

Preferred organic liquid solvents include: ethylene carbonate (EC), dimethyl carbonate (DMC), methylethyl carbonate (MEC), diethyl carbonate (DEC), propylene carbonate (PC), acetonitrile (AN), vinylene carbonate (VC), allyl ethyl carbonate (AEC), 1,3-dioxolane (DOL), and 1,2-dimethoxyethane (DME).

Preferred flame retardant liquid additives are Hydrofluoro ether (FIFE), Trifluoro propylene carbonate (FPC), Methyl nonafluorobutyl ether (MFE), Fluoroethylene carbonate (FEC), Tris(trimethylsilyl)phosphite (TTSPi), Triallyl phosphate (TAP), Ethylene sulfate (DTD), 1,3-propane sultone (PS), Propene sultone (PES), Diethyl carbonate (DEC), Alkylsiloxane (Si—O), Alkyylsilane (Si—C), liquid oligomeric silaxane (—Si—O—Si—), Ttetraethylene glycol dimethylether (TEGDME), canola oil.

Preferred ionic liquid solvents may be selected from a room temperature ionic liquid (RTIL) having a cation selected from tetraalkylammonium, di-alkylimidazolium, alkylpyridinium, dialkyl-pyrrolidinium, or dialkylpiperidinium. The counter anion is preferably selected from BF₄⁻, B(CN)₄⁻, CF₃CO₂, CF₃SO₃⁻, N(SO₂CF₃)₂⁻, N(COCF₃)(SO₂CF₃)⁻, or N(SO₂F)₂⁻. Particularly useful ionic liquid-based solvents include N-n-butyl-N-ethylpyrrolidinium bis(trifluoromethane sulfonyl)imide (BEPyTFSI), N-methyl-N-propylpiperidinium bis(trifluoromethyl sulfonyl)imide (PP₁₃TFSI), and N,N-diethyl-N-methyl-N-(2-methoxyethyl) ammonium bis(trifluoromethylsulfonyl)imide.

### Example 2: Vapor Pressure of Some Solvents and Corresponding Quasi-solid Electrolytes with Various Lithium Salt Molecular Ratios

Vapor pressures of several solvents (DOL, DME, PC, AN, with or without an ionic liquid-based co-solvent, PP₁₃TFSI) before and after adding a wide molecular ratio range of lithium salts, such as lithium borofluoride (LiBF₄), lithium trifluoro-methanesulfonate (LiCF₃SO₃), or bis(trifluoro methanesulfonyl)imide (LiTFSI), and a broad array of electrolyte additives were measured. Some of the vapor pressure ratio data (pₛ/p=vapor pressure of solution/vapor pressure of solvent alone) are plotted as a function of the lithium salt molecular ratio x, as shown in FIG. 2-FIG. 5, along with a curve representing the Raoult's Law. In most of the cases, the vapor pressure ratio follows the theoretical prediction based on Raoult's Law for up to x<0.15 only, above which the vapor pressure deviates from Raoult's Law in a novel and unprecedented manner. It appears that the vapor pressure drops at a very high rate when the molecular ratio x exceeds 0.2, and rapidly approaches a minimal or essentially zero when x exceeds 0.4. With a very low pₛ/p value, the vapor phase of the electrolyte either cannot ignite or cannot sustain a flame for longer than 3 seconds once initiated. More significantly, by adding some amount of the selected retardant additive, one can significantly shift the threshold concentration for non-flammability down to approximately 1.5 M or x=0.12.

Given the same first electrolyte composition, the vapor pressure of the entire cell (prior to sealing of the casing) is further significantly reduced with the presence of a second electrolyte composition having a polymer electrolyte.

### Example 3: Flash Points and Vapor Pressure of Some Solvents and Additives and Corresponding Quasi-Solid Electrolytes with a Lithium Salt Molecular Ratio of x=0.2

The flash points of several solvents (with or without a liquid additive) and their electrolytes having a lithium salt molecular ratio x=0.2 are presented in Table 1 below. It may be noted that, according to the OSHA (Occupational Safety & Health Administration) classification, any liquid with a flash point below 35.7° C. is flammable. However, in order to ensure safety, we have designed our quasi-solid electrolytes to exhibit a flash point significantly higher than 38.7° C. (by a large margin, e.g. at least increased by 50° and preferably above 150° C.). The data in Table 1 indicate that the addition of a lithium salt to a molecular ratio of 0.2 is normally sufficient to meet these criteria provided a selective additive is added into the liquid solvent. The addition of a second electrolyte, introduced after the first electrolyte was injected and permeated into the anode and the cathode, was found to substantially totally suppress the flash point.

TABLE 1
The flash points and vapor pressures of select solvents
and their electrolytes with a lithium salt
molecular ratio x = 0.2 (approximately 2.5 M).

| | Flash | Liquid additive | Flash point (° C.) |
|---|---|---|---|
| | point | (additive/solvent = | with x = 0.2 |
| Liquid solvent | (° C.) | 25/75) | of (Li salt) |
| DOL | 1 | none | 35 (LiBF₄) |
| (1,3-dioxolane) | | | |
| DOL | | TEGDME | 150 (LiBF₄) |
| DOL | 1 | none | 76 (LiCF₃SO₃) |
| DOL | | Ethylene sulfate (DTD) | 155 (LiCF₃SO₃) |
| DEC | 33 | none | 120 (LiCF₃SO₃) |
| (diethyl carbonate) | | | |
| DEC | | FPC (Trifluoro propylene | >200 (LiCF₃SO₃) |
| | | carbonate) | |
| DMC (Dimethyl | 18 | none | 87 (LiCF₃SO₃) |
| arbonate) | | | |
| DMC | | hydrofluoro ether | >180 (LiCF₃SO₃) |
| EMC (ethyl | 23 | none | 88 (LiBOB) |
| methyl carbonate) | | | |
| EMC | | MFE | >200 (LiBOB) |
| AN(Acetonitrile) | 6 | none | 65 (LiBF₄) |
| AN | | 1,3-propane sultone (PS) | 155 (LiBF₄) |
| AN | | Canola oil | 160 (LiBF₄) |
| EA (Ethyl | −3 | none | 70 (LiBF₄) |
| acetate) + DOL | | | |
| EA +DOL | | Triallyl phosphate (TAP) | >180 (LiBF₄) |
| DME (1,2- | −2 | | 55(LiPF₆) |
| dimethoxyethane) | | | |
| DME | | liquid silaxane | 155(LiPF₆) |
| VC (vinylene | 53.1 | none | 65 (LiPF₆) |
| carbonate) | | | |
| VC | | Alkyylsilane (Si-C) | >200 (LiPF₆) |

*As per OSHA (Occupational Safety & Health Administration) classification, any liquid with a flash point below 38.7° C. is flammable.

### Example 4: Lithium Ion Transference Numbers in Several Electrolytes

The Li⁺ ion transference numbers of several types of electrolytes (e.g. LiTFSI salt/(EMImTFSI+DME) solvents and LiPF₆/DEC with or without additives) in relation to the lithium salt molecular ratio were studied and representative results are summarized in FIG. 6-FIG. 8. In general, the Li⁺ ion transference number in low salt concentration electrolytes decreases with increasing concentration from x=0 to x=0.2-0.35. However, beyond molecular ratios of x=0.2-0.35, the transference number increases with increasing salt concentration, indicating a fundamental change in the Li⁺ ion transport mechanism. This was explained in the theoretical sub-sections earlier. Additionally, the incorporation of a liquid additive to the electrolyte does not negatively impact the lithium ion transport behavior. In some cases, the liquid additive actually increases the transference number.

When Li⁺ ions travel in a low salt concentration electrolyte (e.g. x<0.2), a Li⁺ ion can drags multiple solvating anions or molecules along with it. The coordinated migration of such a cluster of charged species can be further impeded if the fluid viscosity is increased due to more salt dissolved in the solvent. In contrast, when an ultra-high concentration of lithium salt with x>0.2 is present, Li⁺ ions could significantly out-number the available solvating anions that otherwise could cluster the lithium ions, forming multi-ion complex species and slowing down their diffusion process. This high Li⁺ ion concentration makes it possible to have more “free Li⁺ ions” (non-clustered), thereby providing a higher Li⁺ transference number (hence, a facile Li⁺ transport). The lithium ion transport mechanism changes from a multi-ion complex-dominating one (with an overall larger hydrodynamic radius) to single ion-dominating one (with a smaller hydrodynamic radius) having a large number of available free Li⁺ ions. This observation has further asserted that an adequate number of Li⁺ ions can quickly move through or from the quasi-solid electrolytes to make themselves readily available to interact or react with a cathode (during discharge) or an anode (during charge), thereby ensuring a good rate capability of a lithium secondary cell. Most significantly, these concentrated electrolytes are non-flammable and safe. The presence of a liquid additive can decrease the required lithium salt concentration to make a non-flammable electrolyte and maintain the liquid flowability for electrolyte injection into the dry battery cells. Combined safety, facile lithium ion transport, good electrochemical performance characteristics, and ease of battery production have been thus far difficult to come by for all types of lithium secondary battery.

### Example 5: Pentaerythritol Tetraacrylate (PETEA)-Based Electrolyte for Use in a Second Electrolyte Composition

A pentaerythritol tetraacrylate (PETEA)-based polymer electrolyte was prepared by gelation of a precursor solution. The precursor solution comprised 1.5 wt % PETEA (C₁₇H₂₀O₈) as a monomer and 0.1 wt. % azobisdiisobutyronitrile (AIBN,C₈H₁₂N₄) as an initiator dissolved in a liquid electrolyte containing 1M bis(trifluoromethane) sulfonamide lithium (LiTFSI) salt in a mixture of 1,2-dioxolane (DOL)/dimethoxymethane (DME) (1:1 by volume) with 1 wt % LiNO₃ additive. This precursor solution was injected into the unfilled space in a battery cell previously loaded with a first electrolyte composition. The precursor solution in the cell was polymerized at 70° C. for half an hour to form the polymer electrolyte in situ.

The radical polymerization of PETEA was thermally initiated by azobisisobutyronitrile (AIBN). The polymerization reaction occurs in liquid electrolyte. The primary radicals derived via the thermal decomposition of AIBN attack the C═C double bond of the PETEA monomer to create four free radicals on the monomer since PETEA possesses four C═C double bonds to be initiated, followed by the chain growth reaction by sequentially adding PETEA monomers to the active sites (i.e., four free radical ends) of initiated monomer. Finally, a three-dimensional network-like polymerized PETEA is formed in liquid electrolyte.

### Example 6: Polymer Electrolyte Based on Cyanoethyl Poly(Vinyl Alcohol) (PVA-CN)

Cyanoethyl poly(vinyl alcohol) polymer was prepared by gelation of a precursor solution containing 2 wt. % PVA-CN dissolved in a liquid electrolyte that contained 1M LiPF₆ in a mixture solution of ethylene carbonate (EC)/dimethyl carbonate (DMC)/ethylmethyl carbonate (EMC) with a volume ratio of 1:1:1. The precursor solution was injected into an unfilled space in a battery cell and then heated at a temperature of 70° C. to obtain black PVA-CN based polymer electrolyte.

### Example 7: Poly(Vinyl Carbonate)-Based Polymer Electrolyte

Liquid vinylene carbonate (VC), in the presence of a lithium salt, can be polymerized into poly(vinyl carbonate) (PVCA) catalyzed by a thermally initialized radical initiator. The lithium salt, lithium difluoro(oxalate) borate (LiDFOB) has the combined chemical structures of lithium bis(oxalate) borate and lithium tetrafluoroborate (LiBF₄). In an experiment, 1.43 g LiDFOB was dissolved in to 10 mL VC to obtain a homogeneous and transparent solution (1.0 m LiDFOB in VC, ≈9.6% (w/w)) and then the solution was added with 10 mg AIBN. The precursor solution was injected into an unfilled space in a battery cell, which was maintained at 60° C. for 24 h and 80° C. for 10 h in a vacuum oven to complete polymerization of VC.

### Example 8: Physical Vapor Deposition (PVD) of Sulfur on Meso-Porous Graphite Worm Conductive Structures for Li—S Cathodes

In a typical procedure, a meso-porous graphite worm structure or a nano-filament web is sealed in a glass tube with the solid sulfur positioned at one end of the glass tube and the web near another end at a temperature of 40-75° C. The sulfur vapor exposure time was typically from several minutes to several hours for a sulfur coating of several nanometers to several microns in thickness. A sulfur coating thickness lower than 100 nm is preferred, but more preferred is a thickness lower than 20 nm, and most preferred is a thickness lower than 10 nm (or even 5 nm). Several lithium metal cells with or without a nano-structured anode were fabricated, wherein a lithium metal foil was used as a source of Li⁺ ions.

### Example 9: Preparation of Graphene-Enabled LiₓV₃O₈ Nano-sheets (as a Cathode Active Material in a Rechargeable Lithium Metal Battery) from V₂O₅ and LiOH

All chemicals used in this study were analytical grade and were used as received without further purification. V₂O₅ (99.6%, Alfa Aesar) and LiOH (99+%, Sigma-Aldrich) were used to prepare the precursor solution. Graphene oxide (GO, 1% w/v obtained in Example 2 above) was used as a structure modifier. First, V₂O₅ and LiOH in a stoichiometric V/Li ratio of 1:3 were dissolved in actively stirred de-ionized water at 50° C. until an aqueous solution of LiₓV₃O₈ was formed. Then, GO suspension was added while stirring, and the resulting suspension was atomized and dried in an oven at 160° C. to produce the spherical composite particulates of GO/LiₓV₃O₈ nano-sheets. Corresponding LiₓV₃O₈ materials were obtained under comparable processing conditions, but without graphene oxide sheets.

An additional set of graphene-enabled LiₓV₃O₈ nano-sheet composite particulates was produced from V₂O₅ and LiOH under comparable conditions, but was dried under different atomization temperatures, pressures, and gas flow rates to achieve four samples of composite particulates with four different LiₓV₃O₈ nano-sheet average thicknesses (4.6 nm, 8.5 nm, 14 nm, and 35 nm). A sample of LiₓV₃O₈ sheets/rods with an average thickness/diameter of 76 nm was also obtained without the presence of graphene oxide sheets (but, with the presence of carbon black particles) under the same processing conditions for the graphene-enhanced particulates with a nano-sheet average thickness of 35 nm. It seems that carbon black is not as good a nucleating agent as graphene for the formation of LiₓV₃O₈ nano-sheet crystals. The specific capacities and other electrochemical properties of these cathode materials in Li metal cells using lithium foil as a counter electrode and in Li-ion cells using a graphite anode were investigated.

### Example 10: Hydrothermal Synthesis of Graphene-Enabled V₃O₇ H₂O Nano-belts from V₂O₅ and Graphene Oxide

In a typical procedure, 0.015 g of V₂O₅ was added into 9 ml of distilled water. A GO-water suspension (V₂O₅/GO ratio of 98/2) was poured into the V₂O₅ suspension. The resulting mixture was transferred to a 35 ml Teflon-sealed autoclave and stored at 180-200° C. for 24-36 h (different batches), then was air-cooled to room temperature. GO was used as a heterogeneous nucleation agent to promote fast nucleation of larger numbers of nuclei for reduced crystallite sizes (promote nucleation against growth of crystals). The products were washed several times with distilled water, and finally dried at 60° C. in an oven.

A second batch was obtained by spray-drying at 200° C. and heat-treated at 400° C. for 2 hours to obtain particulates of GO/V₃O₇ H₂O composite with graphene oxide sheets embracing around these particulates. For comparison purposes, a third batch of V₃O₇ H₂O was prepared without using GO (oven dried), a fourth batch was prepared with GO and poly ethylene oxide (1% PEO in water was added to the GO suspension, then spray-dried and heat-treated at 400° C. for 2 hours), and a fifth batch was prepared with PEO (1% in water, but without GO) via spray-drying, followed by heat-treating at 400° C. for 2 hours. Heat treatment of PEO at 400° C. serves to convert PEO to a carbon material. The particulates of GO/V₃O₇ H₂O composite were used as a cathode active material in a Li metal cell.

### Example 11: Preparation of Electrodes for Li-Ion Cells Featuring a Quasi-Solid Electrolyte

Several dry electrodes containing graphene-enhanced particulates (e.g. comprising lithium cobalt oxide or lithium iron phosphate primary particles embraced by graphene sheets) were prepared by mixing the particulates with a liquid to form a paste without using a binder such as PVDF. The paste was cast onto a surface of a piece of glass, with the liquid medium removed to obtain a dry electrode. Another dry electrode was prepared by directly mixing LiFePO₄ primary particles with graphene sheets in an identical liquid to form a paste without using a binder. Again, the paste was then cast to form a dry electrode. The dry electrodes were for the evaluation of the effect of various conductive additives on the electrical conductivity of an electrode.

For comparison purposes, several additional dried electrodes were prepared under exactly identical conditions, and the paste in each case was made to contain the same cathode active particles, but a comparable amount of other conductive additives: multi-walled carbon nano-tubes (CNTs), carbon black (Super-P from Timcal), a CNT/Super-P mixture at an 1/1 ratio, and a GO/Super-P mixture at an 1/1 ratio. Corresponding “wet” electrodes for incorporation in a battery cell were made to contain a PVDF binder. These electrodes were made into full cells containing graphite particles or lithium metal as an anode active material.

The first-cycle discharge capacity data of small full button cells containing lithium metal as an anode active material were obtained. The data show that the battery cells containing graphene-enhanced particulates in the cathode show superior rate capability to that of a carbon black-enhanced cathode. Most importantly, as compared to the cells featuring a single conventional electrolyte, the Li-ion cells having two electrolytes (one containing a high lithium salt concentration in an organic liquid solvent, plus a second polymer-based electrolyte) typically exhibit a longer and more stable cycling life, experiencing a significantly lesser extent of capacity decay after a given number of charge/discharge cycles. In addition, the cells having two types of electrolytes as herein disclosed did not suffer from any fire or explosion when a nail penetration test was conducted on them. In contrast, the cells containing conventional lithium salt-organic solvent electrolytes all exhibited thermal runaway problems and caught fires.

It may be further noted that the cathode active material that can be used in the presently disclosed electrode is not limited to lithium cobalt oxide and lithium iron phosphate. There is no particular limitation on the type of electrode active materials that can be used in a Li-ion cell featuring the presently disclosed quasi-solid electrolyte.

### Example 12: Li-Air Cells with Ionic Liquid Electrolytes Containing Various Salt Concentrations

To test the performance of the Li-air battery employing an organic liquid solvent with different lithium salt concentrations, several pouch cells with dimension of 5 cm×5 cm were built. Porous carbon electrodes were prepared by first preparing ink slurries by dissolving a 90 wt % EC600JD Ketjen black (AkzoNobel) and 5 wt. % Kynar PVDF (Arkema Corporation) in N-methyl-2-pyrrolidone (NMP). Air electrodes were prepared with a carbon loading of approximately 20.0 mg/cm² by hand-painting the inks onto a carbon cloth (PANEX 35, Zoltek Corporation), which was then dried at 180° C. overnight. The total geometric area of the electrodes was 3.93 cm². The Li/O₂ test pouch cells were assembled in an argon-filled glove box. The cell consists of metallic lithium anode and the air electrode as a cathode, prepared as mentioned above. The copper current collector for anode and the aluminum current collector for cathode were used. A Celgard 3401 separator separating the two electrodes was soaked in LiTFSI-DOL/EMITFSI (6/4) solutions (with different LiTFSI salt concentrations and different electrolyte additives) for a minimum of 24 hours. The cathode was soaked in the oxygen saturated EMITFSI-DOL/LiTFSI solution for 24 hours and was placed under vacuum for an hour before being used for the cell assembly. The cell was placed in an oxygen filled glove box where oxygen pressure was maintained at 1 atm. Cell charge-discharge was carried out with a battery cycler at the current rate of 0.1 mA/cm² at room temperature. It was found that a higher lithium salt concentration in a liquid solvent results in a higher round-trip efficiency for cells (62%, 66%, and 75% for x=0.11, 0.21, and 0.32, respectively) and lower capacity decay after a given number of charge/discharge cycles (25%, 8%, and 4.8% for cells with x=0.11, 0.21, and 0.32, respectively, after 100 cycles). These properties were further improved when a second, in situ cured polymer was introduced into the cell.

### Example 13: Evaluation of Electrochemical Performance of Various Cells

Charge storage capacities were measured periodically and recorded as a function of the number of cycles. The specific discharge capacity herein referred to is the total charge inserted into the cathode during the discharge, per unit mass of the composite cathode (counting the weights of cathode active material, conductive additive or support, binder, and any optional additive combined, but excluding the current collector). The specific charge capacity refers to the amount of charges per unit mass of the composite cathode. The specific energy and specific power values presented in this section are based on the total cell weight. The morphological or micro-structural changes of selected samples after a desired number of repeated charging and recharging cycles were observed using both transmission electron microscopy (TEM) and scanning electron microscopy (SEM).

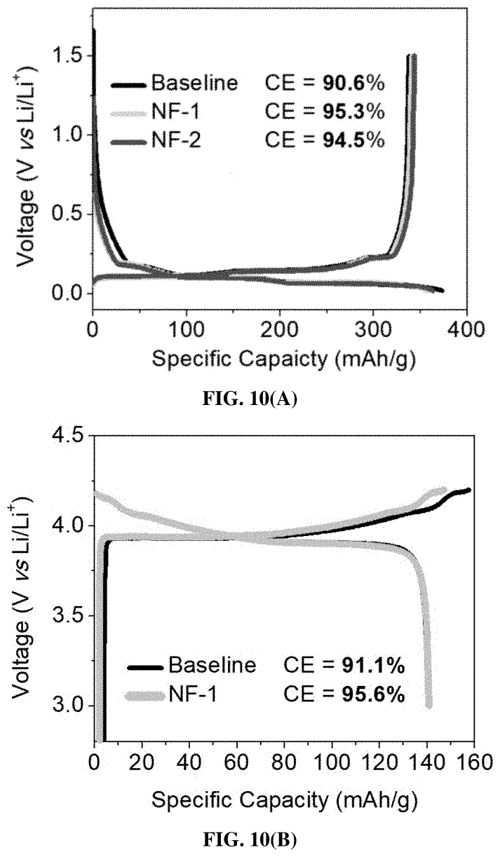

As an example, the first-cycle efficiency (Coulomb efficiency) of several cells was evaluated using a baseline electrolyte of EC+DEC and two non-flammable electrolytes (NF-1 contains FPC and NF-2 contains FEC). The data shown in FIG. 10(A) and FIG. 10(B) have demonstrated that the selected additive can actually increase the Coulomb efficiency of an electrolyte. This is an unexpected and desirable outcome.

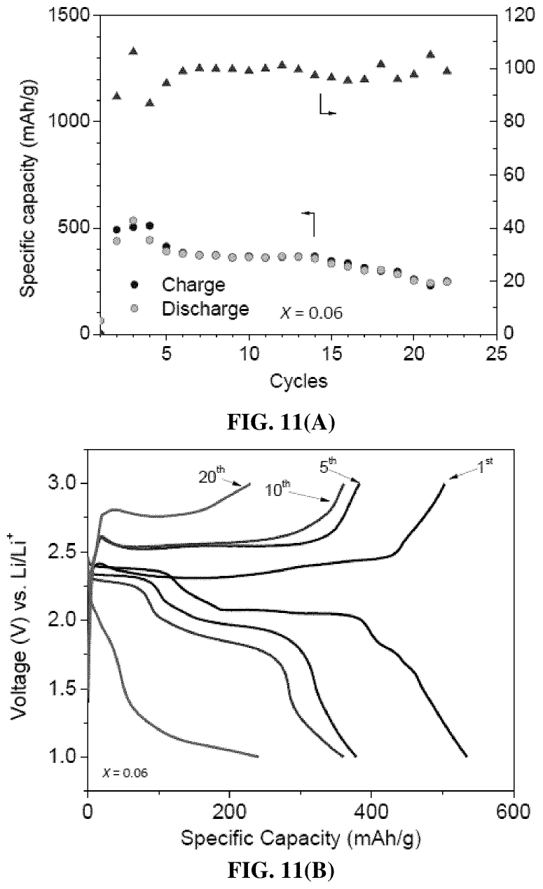

As another example, the cycling performance (charge specific capacity, discharge specific capacity, and Coulomb efficiency) of a Li metal-sulfur cell containing a low-concentration electrolyte (x=0.06 of lithium salt in an organic liquid, approximately 0.8 M) is shown in FIG. 11(A). Some representative charge-discharge curves of the same cell are presented in FIG. 11(B). It is quite clear that the capacity of the cell rapidly decays as charges and discharges are repeated. This is characteristic of conventional Li—S cells that have great propensity for sulfur and lithium polysulfide to get dissolved in the electrolyte at the cathode side. Much of the dissolved sulfur could not be re-deposited to the cathode conductive additive/substrate or the cathode current collector during subsequent charges/discharges. Most critically, as time goes on or when charge/discharge cycling continues, some of the dissolved lithium polysulfide species migrate to the anode side and react with Li to form insoluble products and, hence, these species could not return to the cathode. These phenomena lead to continuing decay in the battery capacity.

We proceeded to investigate how the lithium salt concentration would affect the lithium polysulfide dissolution in an organic solvent, and to determine how concentration changes would impact the thermodynamics and kinetics of the shuttle effect. We immediately encounter some major challenges. First, we did not have a wide range of lithium salt concentrations at our disposal. Most of the lithium salts could not be dissolved in those solvents commonly used in Li-ion or Li—S secondary cells for more than a molar ratio of 0.2-0.3. Second, we quickly came to realize that the viscosity of many organic liquid solvents was already extremely high at room temperature and adding more than 0.2-0.3 molar ratio of a lithium salt in such a viscous solid made the resulting mixture look like and behave like a solid. It was next to impossible to use a stirrer to help disperse the solid lithium salt powder in the liquid solvent. Further, a higher solute concentration was generally believed to be undesirable since a higher concentration normally would result in a lower lithium ion conductivity in the electrolyte. This would not be conducive to achieving a higher power density, lower polarization, and higher energy density (at high charge/discharge rates). We almost gave up, but decided to move forward anyway. The research results have been most surprising.

Contrary to the expectations by electrochemists and battery designers that a significantly higher lithium salt concentration could not be produced, we found that a concentration as high as x=0.2-0.6, roughly corresponding to 3-11 M of a lithium salt in some organic liquid could be achieved, if a highly volatile solvent (such as AN or DOL) is added as a co-solvent first. Once a complete dissolution of a lithium salt in a mixture solvent is attained, we could choose to selectively remove the co-solvent. We were pleasantly surprised to observe that partial or complete removal of the more volatile co-solvent upon complete salt dissolution would not result in crystallization or precipitation of the salt from the organic liquid solvent even though the salt (a solute) was then in a highly supersaturated condition.

We have further defied the expectation of battery chemists and engineers that a higher electrolyte concentration would lead to a lower discharge capacity. Most surprisingly, the Li—S cells contain a higher-concentration electrolyte system exhibit not only a generally higher energy density but also a dramatically more stable cycling behavior and longer cycle life.

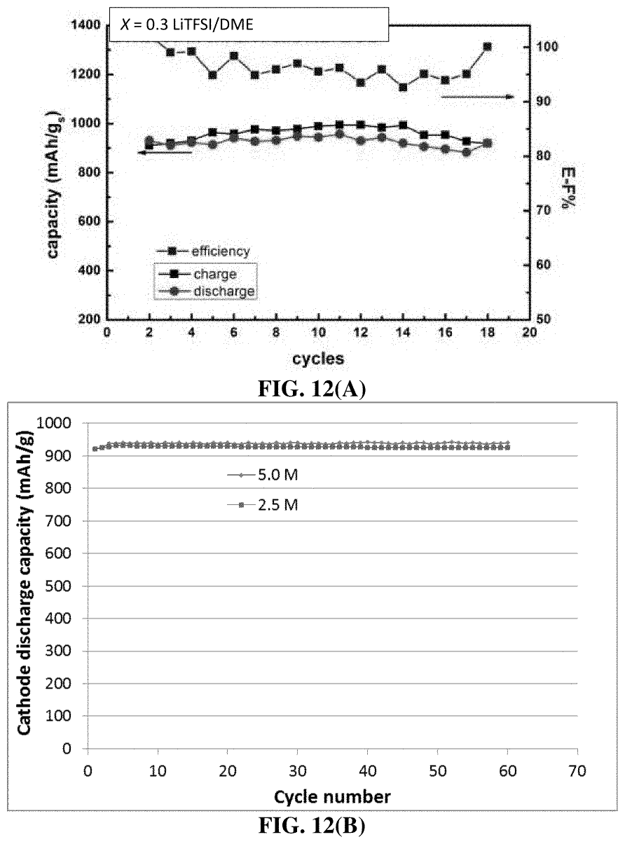

As an example, FIG. 12(A) shows the charge specific capacity, discharge specific capacity, and Coulomb efficiency of a Li metal-sulfur cell containing an organic liquid solvent-based quasi-solid electrolyte (x=0.3). The cycling performance is so much better than that of the corresponding cell having a lower salt concentration as shown in FIG. 11(A) and FIG. 11(B). The specific capacity of this lower concentration cell in FIG. 11(B) decays rapidly as the number of charge/discharge cycles increases. As shown in FIG. 12(B), the cycling behaviors of two corresponding cells having 20% FPC added to DME solvent and having salt concentrations of 2.5 M and 5 M, respectively are all more stable than the cell having x=0.3 (approximately 3.7M) but no electrolyte additive (the cell in FIG. 12(A)) and the one having x=0.06 (the cell in FIG. 11(A)).

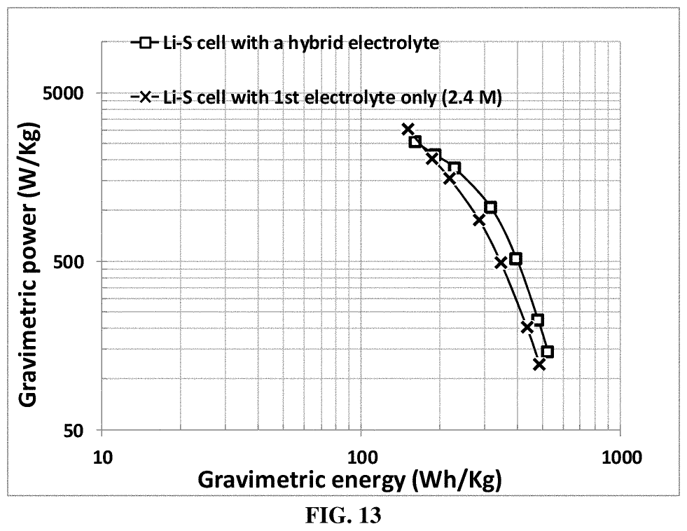

FIG. 13 shows the Ragone plots (cell power density vs. cell energy density) of two Li metal-sulfur cells each having an exfoliated graphite worm-sulfur cathode, but different electrolytes; one cell containing the first electrolyte composition only (the lithium salt concentrations being 2.4 M, with a flame retardant additive) and the other cell containing this first electrolyte and a second electrolyte based PVA-CN discussed in Example 6. The first cell, having a first electrolyte only, delivers a higher power density, but lower energy density. The energy density of the second cell having the hybrid electrolytes is as high as 527 Wh/kg. This is 2 times higher than the energy density of a conventional lithium-ion battery.

In summary, the present disclosure provides an innovative, versatile, and surprisingly effective platform materials technology that enables the design and manufacture of superior lithium metal and lithium-ion rechargeable batteries. The lithium-sulfur cell featuring a high-concentration electrolyte system having a select additive exhibits a stable and safe anode (no dendrite-like feature), high lithium utilization rate, high cathode active material utilization rate, high specific capacity, high specific energy, high power density, little or no shuttling effect, and long cycle life. The approach of adding a second electrolyte, a polymer-based one, imparts additional safety features to battery cells.

1. A rechargeable lithium cell comprising a cathode having a cathode active material, an anode having an anode active material, a separator electronically separating said anode and said cathode, a non-flammable quasi-solid electrolyte comprising two electrolyte compositions:
(a) A first electrolyte composition in physical contact with said cathode and said anode, wherein said first electrolyte composition contains a lithium salt dissolved in a mixture of a liquid solvent and a flame-retardant additive, having a lithium salt concentration C1; from 1.5 M to 14.0 M so that said electrolyte exhibits a vapor pressure less than 0.01 kPa when measured at 20° C., a vapor pressure less than 60% of the vapor pressure of said liquid solvent alone, a flash point at least 20 degrees Celsius higher than a flash point of said liquid solvent alone, a flash point higher than 150° C., or no flash point; and
(b) A second electrolyte composition, comprising a polymer electrolyte in ionic contact with said first electrolyte composition and being disposed between the anode and the cathode, between the separator and the cathode and/or between the separator and the anode.

2. The rechargeable lithium cell of claim 1, wherein said flame-retardant additive, different in composition than said liquid solvent, is selected from Hydrofluoro ether (HFE), Trifluoro propylene carbonate (FPC), Methyl nonafluorobutyl ether (MFE), Fluoroethylene carbonate (FEC), Tris(trimethylsilyl)phosphite (TTSPi), Triallyl phosphate (TAP), Ethylene sulfate (DTD), 1,3-propane sultone (PS), Propene sultone (PES), Alkylsiloxane (Si—O), Alkyylsilane (Si—C), liquid oligomeric silaxane (—Si—O—Si—), Ttetraethylene glycol dimethylether (TEGDME), canola oil, or a combination thereof and said additive-to-said liquid solvent ratio in said mixture is from 5/95 to 95/5 by weight.

3. The rechargeable lithium cell of claim 1, wherein said lithium salt concentration Ci is from 1.5 M to 14.0 M so that said electrolyte exhibits a vapor pressure less than 0.01 kPa when measured at 20° C., a vapor pressure less than 60% of the vapor pressure of said liquid solvent alone, a flash point at least 20 degrees Celsius higher than a flash point of said liquid solvent alone, a flash point higher than 150° C., or no flash point;

4. The rechargeable lithium cell of claim 1, wherein said concentration is from 1.75 M to 5.0 M.

5. The rechargeable lithium cell of claim 1, wherein said liquid additive-to-said liquid solvent ratio in said mixture is from 15/85 to 85/15 by weight.

6. The rechargeable lithium cell of claim 1, wherein said polymer electrolyte comprises a polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

7. The rechargeable lithium cell of claim 1, wherein said anode or said cathode is substantially free of the second electrolyte composition.

8. The rechargeable lithium cell of claim 1, wherein said first electrolyte has a lithium ion transference number is from 0.4 to 0.9.

9. The rechargeable lithium cell of claim 1, which is a lithium metal secondary cell, a lithium-ion cell, a lithium-sulfur cell, a lithium-ion sulfur cell, a lithium-selenium cell, or a lithium-air cell.

10. The rechargeable lithium cell of claim 1, wherein said liquid solvent is selected from the group consisting of 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofluoroether, and combinations thereof.

11. The rechargeable lithium cell of claim 1, wherein said lithium salt is selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphates (LiPF₃(CF₂CF₃)₃), lithium bisperfluoro-ethylsulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

12. The rechargeable lithium cell of claim 1, wherein a molar fraction or molecular fraction of said lithium salt in said first electrolyte composition is greater than 0.2 and up to 0.99.

13. The rechargeable lithium cell of claim 1, wherein said liquid solvent contains an ionic liquid.

14. The rechargeable lithium cell of claim 13, wherein said ionic liquid is selected from a room temperature ionic liquid having a cation selected from tetraalkylammonium, di-, tri-, or tetra-alkylimidazolium, alkylpyridinium, dialkyl-pyrrolidinium, dialkylpiperidinium, tetraalkylphosphonium, trialkylsulfonium, or a combination thereof.

15. The rechargeable lithium cell of claim 13, wherein said ionic liquid is selected from a room temperature ionic liquid having an anion selected from BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, or a combination thereof.

16. A method of producing the rechargeable lithium cell of claim 1, said method comprising (A) preparing a lithium cell comprising an anode having an anode active material, a cathode having a cathode active material, a porous separator or ion-permeable membrane electronically separating the anode and cathode, and a first electrolyte composition that permeates into the anode and/or the cathode, wherein said first electrolyte composition contains a lithium salt dissolved in a mixture of a liquid solvent and a flame-retardant additive and wherein said lithium cell has an unfilled space; and (B) introducing a second electrolyte composition into said unfilled space, said second electrolyte composition comprising a polymer electrolyte in ionic contact with said first electrolyte composition and being disposed between the anode and the cathode, between the separator and the cathode, and/or between the separator and the anode.

17. The method of claim 16, wherein the flame-retardant additive, different in composition than said liquid solvent, is selected from Hydrofluoro ether (HFE), Trifluoro propylene carbonate (FPC), Methyl nonafluorobutyl ether (MFE), Fluoroethylene carbonate (FEC), Tris(trimethylsilyl)phosphite (TTSPi), Triallyl phosphate (TAP), Ethylene sulfate (DTD), 1,3-propane sultone (PS), Propene sultone (PES), Alkylsiloxane (Si—O), Alkyylsilane (Si—C), liquid oligomeric silaxane (—Si—O—Si—), Ttetraethylene glycol dimethylether (TEGDME), canola oil, or a combination thereof and said additive-to-said liquid solvent ratio in said mixture is from 5/95 to 95/5 by weight.

18. The method of claim 16, wherein said polymer electrolyte comprises a polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

19. The method of claim 16, wherein step (B) comprises a procedure of introducing a precursor monomer, oligomer, or un-cured version of said polymer electrolyte into said unfilled space and then polymerizing and/or curing the precursor inside said battery cell to form said polymer electrolyte

20. The method of claim 16, wherein said step (A) comprises a procedure (i) of assembling said anode, cathode, and said separator or membrane, along with a cell housing together to form a dry battery cell having initially no electrolyte therein and a procedure (ii) of introducing a first electrolyte composition into said dry cell, enabling said first electrolyte to permeate into the anode and/or the cathode; and wherein said step (B) is conducted after procedure (ii).

21. The method of claim 16, wherein said method further comprises, after procedure (ii) but before step (B), a procedure of removing a desired portion of the liquid solvent from said battery cell to create additional unfilled space.

22. A method of producing a rechargeable lithium cell, said method comprising (A) preparing a lithium cell comprising an anode having an anode active material, a cathode having a cathode active material, a porous separator or ion-permeable membrane electronically separating the anode and cathode, and a first electrolyte composition that permeates into the anode and/or the cathode, wherein said first electrolyte composition contains a lithium salt dissolved in a liquid solvent and wherein said lithium cell has an unfilled space; and (B) introducing a second electrolyte composition into said unfilled space, said second electrolyte composition comprising a polymer electrolyte in ionic contact with said first electrolyte composition and being disposed between the anode and the cathode, between the separator and the cathode, and/or between the separator and the anode.

23. The method of claim 22, wherein the first electrolyte composition has a lithium salt concentration from 1.5 M to 14.0 M.

24. The method of claim 22, wherein said polymer electrolyte comprises a polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

25. The method of claim 22, wherein step (B) comprises a procedure of introducing a precursor monomer, oligomer, or un-cured version of said polymer electrolyte into said unfilled space and then polymerizing and/or curing the precursor inside said battery cell to form said polymer electrolyte.

26. The method of claim 22, wherein said step (A) comprises a procedure (i) of assembling said anode, cathode, and said separator or membrane, along with a cell housing together to form a dry battery cell having initially no electrolyte therein and a procedure (ii) of introducing a first electrolyte composition into said dry cell, enabling said first electrolyte to permeate into the anode and/or the cathode; and wherein said step (B) is conducted after procedure (ii).

27. The method of claim 22, wherein said method further comprises, after procedure (ii) but before step (B), a procedure of removing a desired portion of the liquid solvent from said battery cell to create additional unfilled space.

28. A rechargeable lithium cell comprising a cathode having a cathode active material, an anode having an anode active material, a non-flammable quasi-solid electrolyte comprising two electrolyte compositions:
(a) A first electrolyte composition in physical contact with said cathode and said anode, wherein said first electrolyte composition contains a lithium salt dissolved in a mixture of a liquid solvent and a flame-retardant additive, having a lithium salt concentration C1; from 1.5 M to 14.0 M so that said electrolyte exhibits a vapor pressure less than 0.01 kPa when measured at 20° C., a vapor pressure less than 60% of the vapor pressure of said liquid solvent alone, a flash point at least 20 degrees Celsius higher than a flash point of said liquid solvent alone, a flash point higher than 150° C., or no flash point; and
(b) A second electrolyte composition, comprising a polymer electrolyte in ionic contact with said first electrolyte composition and being disposed between the anode and the cathode.
